(19) United States
(12) Patent Application Publication
(10) Pub. No.: US 2009/0006118 A1
(43) Pub. Date: Jan. 1, 2009

(54) System and method for providing competitive pricing for automobiles

(76) Inventor: Dale Pollak, Burr Ridge, IL (US)

Correspondence Address: Jeffrey A. Pine;VALAUSKAS & PINE LLC, Suite 1825, 150 North Wacker Drive, Chicago, IL, 60606, US

(21) Appl. No.: 12/077,081

(22) Filed: Mar. 14, 2008

Related U.S. Application Data
(60) Provisional application No. 60/918,552, filed on Mar. 16, 2007.
(60) Provisional application No. 60/931,717, filed on May 25, 2007.

(51) Int. Cl. G06Q 10/00; G06F 17/00; G06Q 30/00

(52) U.S. Cl. 705/1; 705/400

(57) ABSTRACT

A preferred embodiment of the invention includes a method and system to provide a competitive pricing tool so that automobile dealers can more efficiently and effectively price their used vehicles. The system achieves the optimal sales price by obtaining the relevant pricing and mileage of vehicles for sale that are similarly situated to the focus vehicle. Once the information is obtained, the system creates a value ranking for each of the vehicles for sale and for the focus vehicle. The user is then able to revise the focus vehicle pricing to determine the optimal sales price.

This application claims the benefit of U.S. Provisional Application No. 60/918,552, filed Mar. 16, 2007 and U.S. Provisional Application No. 60/931,717, filed May 25, 2007.

### FIELD OF THE INVENTION

The present invention relates to a novel competitive pricing system and method directed to assist retailers in more effectively and efficiently pricing their products. The system has features especially adapted for use with the used vehicle business environment; although it is contemplated that alternate embodiments of the invention would be applicable to other types of businesses. A novel ranking system is utilized that recognizes the relationship of certain variables to the price of the goods thereby simulating the consumer's mental process of narrowing and prioritizing a wide range of generally similar products into a manageable list.

In the preferred embodiment, the system of the present invention recognizes a relationship between a used car's mileage and the price. The present invention ranks competitive vehicles based on at least this relationship, and provides an automobile dealer with information about the pricing for that particular dealer's used cars. The retailer can revise its prices accordingly to decrease the amount of time to sell the used vehicle, increase the profit from the sale of the used vehicle, or both. Thus, the system and method assists the retailer in determining optimal pricing for the sale of a used car based on the retailer's objectives.

### BACKGROUND OF THE INVENTION

The pre-owned vehicle market is quite substantial. It has been estimated that there are in existence over 50,000 pre-owned vehicle locations in the U.S. when franchises and independent locations are considered. As many as 25 million vehicles are acquired and sold from these businesses. Used vehicle departments contribute significantly to dealership profitability when properly managed, and are a primary source of financial liquidity. As a result, many new vehicle dealerships consider used vehicle sales essential for maintaining the ability to conduct new vehicle sales transactions.

The key processes of used vehicle department operations include the appraisal and purchase of used vehicles for stock. Further, the maintenance of current inventory to ensure maximum gross profit and original equity is important for optimal business performance. Finally, the management of used vehicle sales transactions is necessary to ensure meeting business objectives.

The used vehicle department has a number of inherent vulnerabilities. The used vehicle marketplace is highly volatile. The wide variety of new vehicle makes and models presents a challenge even to seasoned appraisers and salespersons in obtaining current valuation information and making accurate appraisals. The widespread use of transitory new vehicle incentives causes disruptions in the marketplace. Consolidation of ownership causes separation of key stakeholders from used vehicle department decision making.

There are typically multiple managers authorized to make key decisions on appraising, purchasing and selling used vehicle inventory. At any given time, not all managers will have up-to-date information or expertise. Further, the environment surrounding appraising, buying and selling is often charged with emotion, which adds another layer of complexity to decision making processes. As a result, objective assessment of a vehicle purchase or sale is made difficult and the real value of a transaction is obscured by factors other than the financial and operating objectives of the dealership.

The used vehicle department also has a number of weaknesses not addressed by present methods. For example, there is limited accountability for key decisions. Key decisions, for example, purchasing, stocking and disposition are made with individual skills, experience and judgment and often without support of empirical information. There are frequent internal and external opportunities for fraud. There exists a minimal amount of usable technology and/or business intelligence to support decision making at several levels of operation and accountability. With respect to business technology and intelligence, used vehicle operations have, to a large extent, resisted integration with electronic valuation information, for example, and have continued without the benefit of the most current supporting information and/or technology.

There is a demand for a system and method that provides relevant information in a current time frame, builds strategy awareness, and provides accountability for a used vehicle department. The present invention satisfies the demand.

### SUMMARY OF THE INVENTION

There are, in view of the above and other reasons, numerous opportunities to improve the performance of used vehicle departments, especially by effectively and efficiently pricing a used automobile to reduce the amount of time to sell that vehicle, to increase the amount of profit from that vehicle, or, in some cases, both of these.

The system and method of the present invention contemplates working in conjunction with and enhancing the vehicle appraisal system set forth in U.S. patent application Ser. No. 11/332,935, titled “System and Method for Managing Business Performance,” which is incorporated by reference herein. The present invention provides a competitive pricing tool for dealers so that they can more efficiently and effectively price their used vehicles. The present invention requires cutting edge Internet harvesting technology, to gather detailed Internet data. A proprietary harvesting system has been developed and deployed for more specific functionality.

The preferred embodiment of the present invention is a proprietary ranking system that recognizes a relationship between the mileage on a used vehicle and the asking price in order to “rank” competitive vehicles. The purpose of the ranking is to simulate the consumer's mental process of narrowing and prioritizing a wide range of generally similar vehicles into a manageable “shopping list”. Although the used vehicle's mileage is one variable, the invention contemplates additional factors in the ranking formula (for example, trims, distance, and specific equipment such as navigation systems).

Further, the present invention may include similar functionality for new vehicles, recognizing other variables, such as the MSRP. Additional functionality of the present invention includes the tracking and comparing of the final sale price for a vehicle with its initial asking price. The present invention will track and monitor the interval at which unique vehicles become available for sale, have price modifications, and are removed from the market. With this tracking, reports can be generated for management detailing the discount from the initial Price as well as market trends including “days supply” of “uniquely configured vehicles”, and the expected number of “days to sale” at any given price point.

Further, the present invention introduces functionality called “vMax” that automatically maximizes the asking price based on any selected “effective vRank” or “vRank”. The vMax functionality finds the highest possible price while maintaining a pre-selected market rank position, i.e., vRank or effective vRank. A user can use the vMax functionality to determine the optimal price for a given vehicle, recognizing its current market position with respect to its competitors, and the strategic value of that position. The user has the ability to have the vMax functionality automatically set prices for its used inventory. Further, the vMax functionality will serve as the foundation for developing, setting and implementing internal and/or an internet pricing strategies for at least one used vehicle in inventory.

The invention includes configurable pricing models. These models allow the application to recommend specific vehicle prices based on the variety of user selected parameters including but not limited to: desired gross profit, inventory turn, and days supply.

The invention includes a method that will track the attributes that users select to define the profile of competitive vehicles. Using proprietary algorithms based on factors such as, but not limited to, frequency and geography, the system will automatically redefine competitive vehicle profiles for similar prospective analysis. These automatically generated competitive vehicle profiles are called “default profiles”.

The present invention allows dealers to use the pricing tool to “operationalize” a pricing strategy. Initially, pricing strategies would be based on, for example, the grid shown below as a function of % of market and age.

| | Age (in days) | | | |
|---|---|---|---|---|
| | 0-10 | 11-20 | 21-30 | 31+ |
| Price (as a % of | % market | % market | % market | % market |
| market) | | | | |

The present invention includes a pricing strategy that would also be formulated as a function of other variables such as rank, score, or days supply. Therefore, the pricing plan utility will utilize other such pricing strategies.

In order to operationalize a pricing strategy, two numbers need to be added to the “List Price” column for each vehicle. Under the “List Price”, the present invention also has “Plan Price”, and “Difference”. The “Plan Price” would automatically fill for dealers with an “operationalized” pricing strategy according to the dealership's set strategy. The “Difference” would also automatically fill as the difference, in dollars, between the “List Price” and “Plan Price” for that vehicle. For those dealerships without an operational plan, the “Plan Price” and “Difference” would be blank.

A dealer must be able to either “disregard”, “accept” or “override” the “Plan Price.” Therefore, the “Plan Price” will need to display differently to distinguish whether it is still a proposed “automatic fill” entry based on the pricing strategy (which is recommended), an accepted automatic fill plan price, or a “override” entry. The purpose of displaying each of these three price conditions differently is to identify whether a plan price was determined automatically and not approved (recommended), determined automatically and “approved”, or plan price override or manually entered. Accepted and override price changes (2 and 3 above) should flow into the daily updated change report.

There are a number of effective and efficient ways of accepting or overriding a “Plan Price.” Until a dealer accepts any price change and, subsequently, the dealership's DMS/internet has been updated to incorporate the change, there will be a “Difference” between the “Plan Price” and the “List Price”.

For dealers with an operationalized pricing strategy, the “Plan Price” will update automatically to a new “Plan Price” (recommended) when the vehicle has an event (like a birthday with an aged based plan) which moves it into a new price category.

The default sort upon opening the pricing tool to the inventory page for dealers with a pricing strategy will be “Difference”, highest to lowest. This will allow a user to immediately focus on which vehicles in inventory are not priced in line with the dealership's strategy, either because a manager has not accepted a price change or because the DMS/internet has not been properly updated.

As previously mentioned, the present invention measures and quantifies the day's supply of a uniquely configured vehicle in the marketplace. Using days supply data, the method will include the functionality to model the relationship between the days supply of a uniquely configured vehicle and its retail price such that at any given price point, the model will be able to quantify or predict how many days it will take for the given vehicle to sell.

Another objective of the present invention is that a user will have the ability to input at least one price and dynamically obtain the number of “days to sale” for such vehicle at that given market price. Similarly, a user will have the ability to input the desired days to sell for at least one uniquely configured vehicle in order to dynamically obtain the retail price required to obtain this sales objective. In addition, this invention contemplates the ability to model price sensitivity to other variables including but not limited to days supply.

Another objective of the present invention includes an appraisal module which embodies a variety of traditional third party valuation guide data sets. Examples include but are not limited to: wholesale auction transactions, Kelley Blue Book, Black Book, NADA guidebook, and Galves. In addition, the invention includes a novel approach to viewing the retail market value for any vehicle contemplated for purchase. This approach includes information displayed in a similar format to that referenced in FIG. 18. In addition, the appraisal module will contain another method of assessing the relationship among the proposed acquisition amount, the dealership's “goals”, and the present retail market/wholesale market. A representation of this is shown in FIG. 19, or “vAuto four square.”

The detailed description of the invention herein is intended to merely be an example and is in no way intended to limit the scope of the invention to this example. Accordingly, modifications to the description are possible, and it should be clearly understood that the invention may be practiced in many different ways than the example specifically described herein, and still remain within the scope of the invention and the claims.

### BRIEF DESCRIPTION OF THE DRAWINGS

While the claims concluding the specification particularly point out and distinctly claim the precise subject matter regarded as the sum and substance of the present invention, its construction and composition may be best understood from the following detailed description taken in connection with the accompanying drawings, in which:

FIG. 1 shows the main view of a system according to one embodiment of the present invention;

FIG. 2 shows one embodiment of a system according to the present invention.

FIG. 3 shows a view of the system according to one embodiment of the present invention;

FIG. 4 shows a detail view of a system according to one embodiment of the present invention;

FIGS. 5A and 5B show the drop down views of a system according to one embodiment of the present invention;

FIG. 6 shows a detail view of the system according to one embodiment of the present invention;

FIG. 7 shows a supply trend chart according to one embodiment of the present invention;

FIGS. 8A and 8B show a notification view of the system according to one embodiment of the present invention;

FIG. 9 shows a price change approval view of the system according to one embodiment of the present invention;

FIG. 10 shows a competitive set profile view of the system according to one embodiment of the present invention;

FIG. 11 shows a profit profile view of the system according to one embodiment of the present invention;

FIG. 12 shows a pricing overview of the system according to one embodiment of the present invention;

FIG. 13 shows a daily summary report of the system according to one embodiment of the present invention;

FIG. 14 shows a yellow car report of the system according to one embodiment of the present invention;

FIG. 15 shows a dealers' report of the system according to one embodiment of the present invention;

FIG. 16 shows a vehicle data entry page of the system according to one embodiment of the present invention;

FIG. 17 shows a dealership current inventory report of the system according to one embodiment of the present invention;

FIG. 18 shows a stock item report of the system according to one embodiment of the present invention;

FIGS. 19 A-C show an alternative method of displaying and assessing the relationship among the acquisition amount, dealership goals and the present retail market;

FIG. 20 shows a table modeling the relationship between the days to sell of a vehicle and its retail price according to one embodiment of the present invention.

FIG. 21 shows a stock item report of the system according to another embodiment of the present invention;

FIG. 22 shows a chart and pie graph demonstrating the days in inventory ranking summary according to one embodiment of the present invention.

FIG. 23 shows a schematic drawing of the computer system according to one embodiment of the present invention;

FIG. 24 shows a screen shot of the Price Tool window according to one embodiment of the present invention;

FIG. 25 shows a screen shot of the Investment Summary window according to one embodiment of the present invention;

FIG. 26 shows a screen shot of the Appraisal Summary window according to one embodiment of the present invention;

FIG. 27 shows a screen shot of the dealer's inventory according to one embodiment of the present invention;

FIG. 28 shows a screen shot of the Vehicle Detail window according to one embodiment of the present invention;

FIG. 29 shows a screen shot of the Pending Price Report according to one embodiment of the present invention;

FIG. 30 shows a screen shot of the Competitive Set according to one embodiment of the present invention;

FIG. 31 shows a screen shot of the Appraisal window according to one embodiment of the present invention;

FIG. 32 shows a screen shot of the Inventory Stocking Summary window according to one embodiment of the present invention;

FIG. 33 shows a screen shot of the Heat Sheet window according to one embodiment of the present invention;

FIG. 34 shows a second screen shot of the Heat Sheet window according to one embodiment of the present invention;

FIG. 35 shows a screen shot of the Buy List window according to one embodiment of the present invention;

### DETAILED DESCRIPTION OF A PRESENTLY PREFERRED EMBODIMENT

### The Main View Function

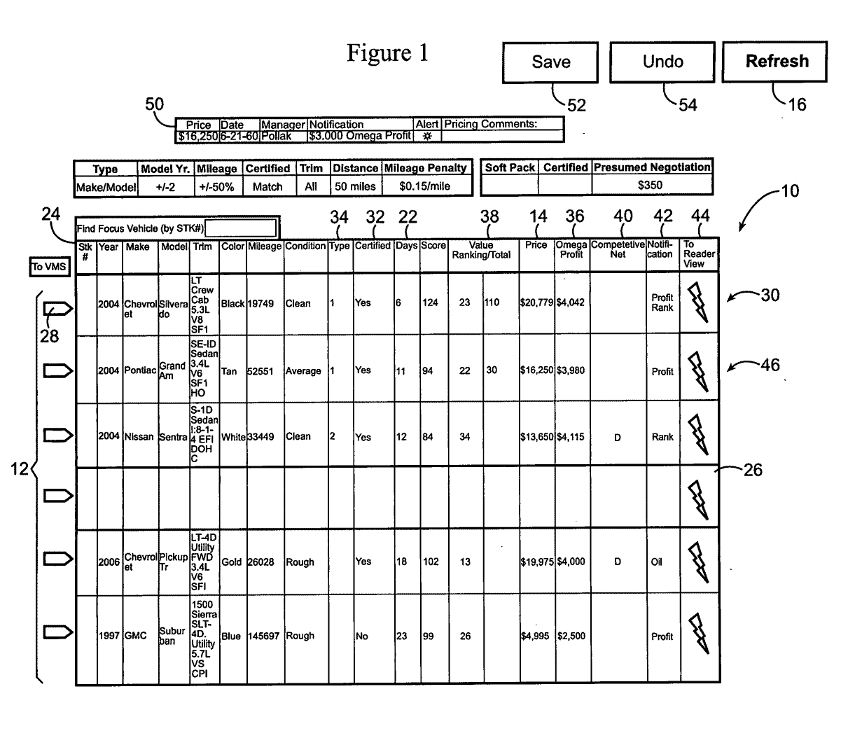

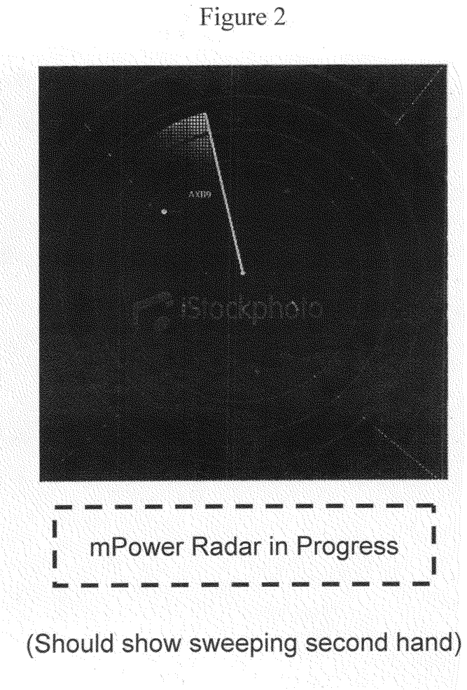

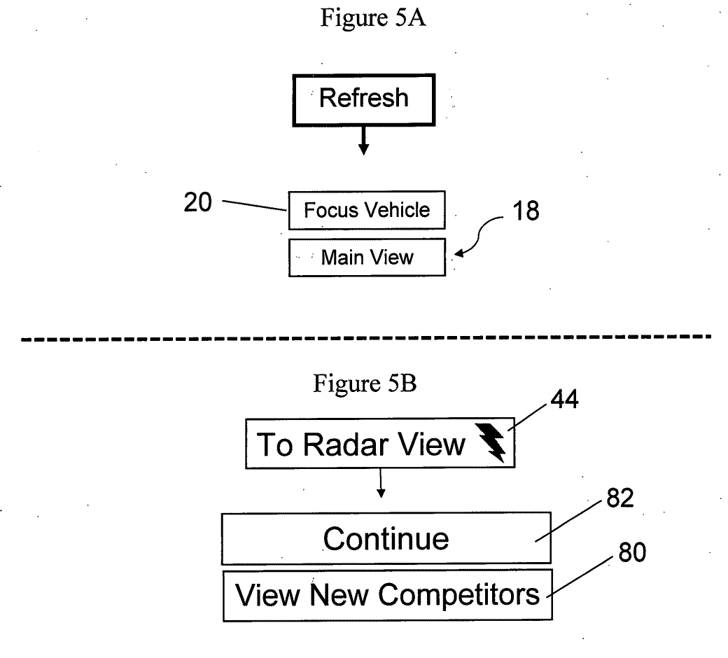

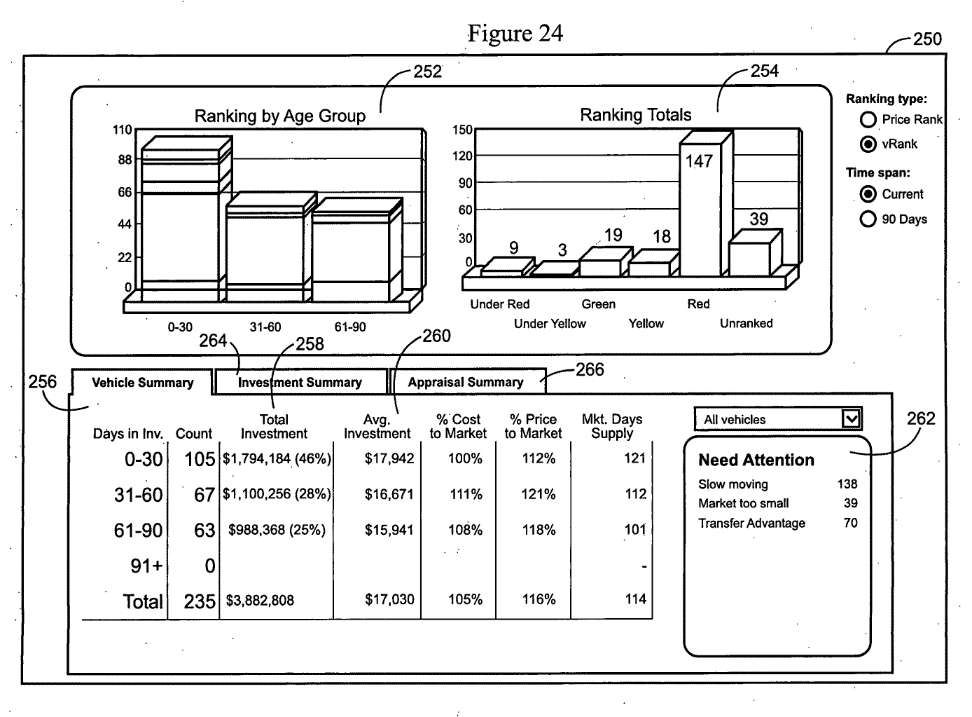

The present invention is web-based and therefore easily accessible for the user, i.e., the automobile dealer, over the Internet, for example. FIG. 1 shows an example of a Main View grid 10 that a user will see once logged into the system of the present invention (FIGS. 24 through 31, as described in detail herein, show screen shots of the preferred embodiment). Among other things, the grid 10 will display current inventory 12 and pricing information 14 updated from both the DMS and a proprietary program, Automated Radar Scan, which as described herein, harvest or gathers necessary vehicle data from various locations on the Internet. This data will automatically update daily. In addition, a user can request a manual refresh, which will provide the current data at that time. The user can select the Refresh button 16 from the Main View menu 10 to receive the Refresh drop-down menu 18 (shown in FIG. 5A). The user can enter information for a particular vehicle 20 and the results will be updated automatically.

The Main View grid 10 will initially display vehicles 12 in order of days 22, freshest to oldest. This screen can be sorted by days 22, or any other variable, and printed accordingly. The present invention provides an easy method of instantly placing focus on a particular vehicle 12, the focus vehicle, using the stock number 24 as an identifier. On the Main View 10, there are two types of data, defaulted and modified. There is a clear visual indication that denotes whether or not a vehicle has been modified, or that vehicle specifications have been entered. The Main View 10 will highlight vehicles, for example in red 26, that have not been modified. These vehicles can be modified by clicking on the pencil icon 28 located to the left of each data row 30, which will connect the user to the current mPower Auto Vehicle Maintenance Screen (as described in U.S. patent application Ser. No. 11/332,935). Modifying the Vehicle Specifications will automatically update the Main View screen 10 on the system of the present application.

The Main View 10 will show additional fields of data for each vehicle. Specifically, there will be fields denoting whether or not a vehicle is certified 32, its type 34, its price 14, its Omega Profit 36, a Value Ranking 38, a Competitive Set Indicator 40, a Vehicle Notification Indicator (on/off) 42, as well as a Radar Link 44. Also, if the Vehicle Notification is on Alert, that vehicle row will be shaded yellow 46, for example, denoting a Yellow Car. The Omega Profit 36 and Competitive Set Indicator 40 fields may also be shaded 48 to indicate that a user has manually overwritten the default settings. This shading is necessary to denote overrides when the screen 10 is printed for use in paper form.

When a focus vehicle is designated, the cursor will move to highlight this vehicle. The Main View 10 will then display the following detailed information at the top of the screen 50, corresponding to the focus vehicle: the Update Detail, the Competitive Set Bar 40, and the Omega Profit Bar 36. This information will dynamically “fill” and populate with a focus vehicle's details as the cursor moves over the Main View 10. Users will be able to test various scenarios by modeling Price 14, Value Ranking 38 and/or Omega Profit 36 while in the Main View 10.

Once a new value is entered, all other dependent fields will dynamically update and recalculate accordingly. Users can also override the Default Competitive Set Profile 40 as well as the Default Omega Profit Profile 36 from the Main View 10. Once a new profile is entered, all other dependent fields will dynamically update and recalculate accordingly. Changes will not be saved until the user clicks the SAVE button 52. As described in more detail below, this functionality will permit a user to model various pricing scenarios. The user will be prompted to SAVE 52 or UNDO 54 after modeling one vehicle, before beginning on another, or exiting the application.

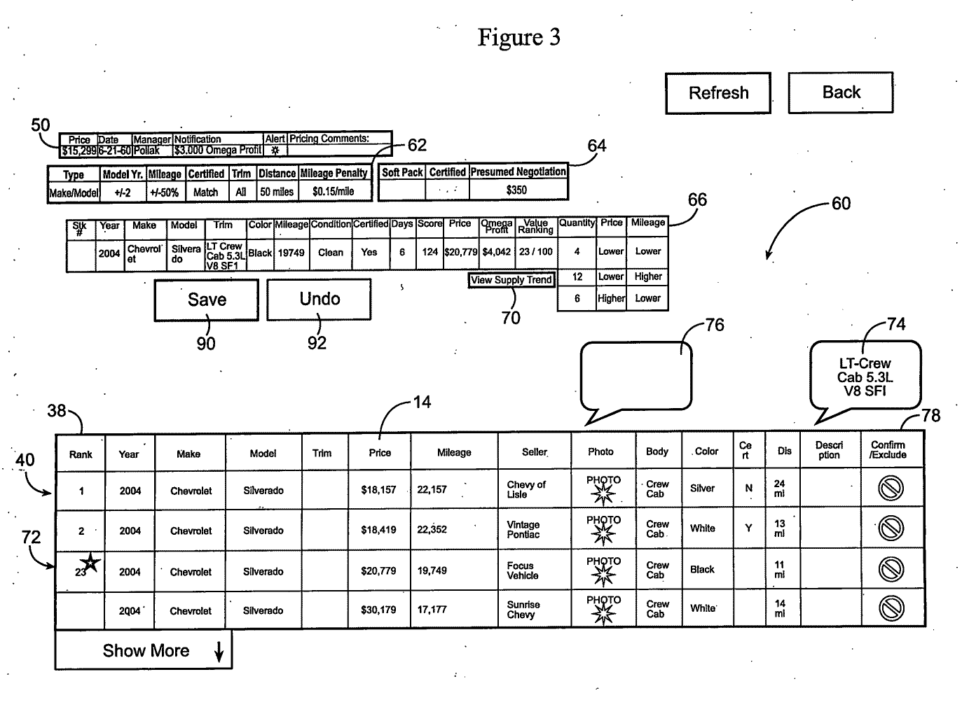

FIG. 3 shows the Radar View function 60. In the Radar View 60, as well as in the Main View 10, values can be overwritten and modeled. The Main View 10 reflects any modeling and/or overriding that is done on the Radar View 60 as the Radar View 60 reflects any modeling and/or overriding that is done on the Main View 10. In other words, the user is able to move seamlessly between the Main View 10 and the Radar View 60.

### The Radar View Function

The Main View 10 will link, by vehicle, to both the current mPower Auto Inventory Maintenance screen using the pencil icon 28, as well as linking to the Radar View 60 by clicking on the Radar Link 44.

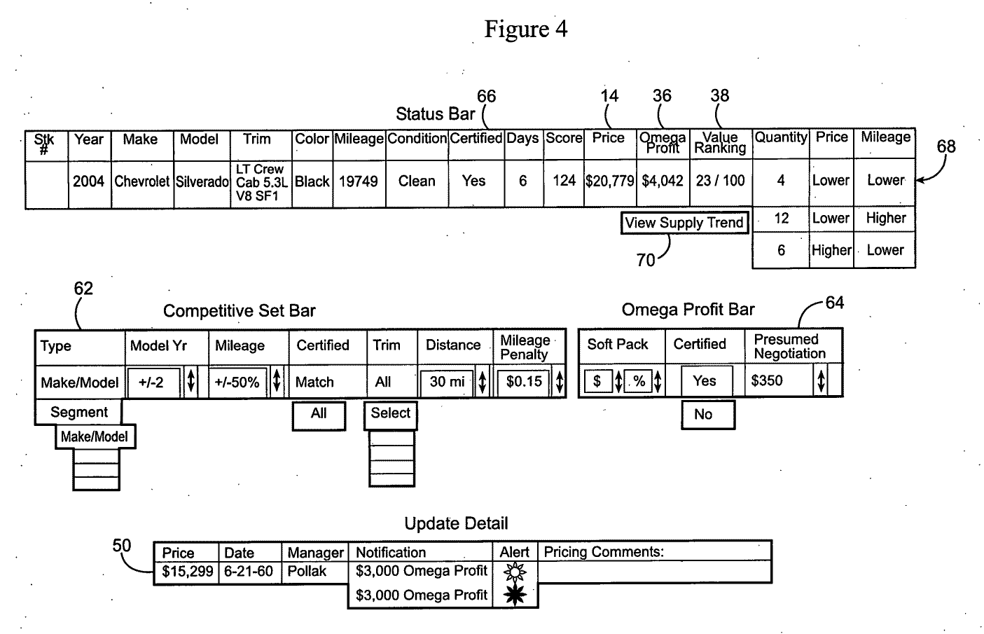

FIG. 3 shows the Radar View 60. When a user is modeling a price 14, it is helpful to understand the pricing of competitive vehicles. Specifically, the user may want to understand what vehicles are ranked ahead of their focus vehicle according to Value Ranking 38. The Radar View 60, when opened, displays the Update Detail 50 for the focus vehicle (see FIG. 4 for the Radar Detail). The Radar View 60 also displays the Competitive Set Bar 62 and the Omega Profit Bar 64 for the focus vehicle (see FIG. 4 for the Radar Detail), along with a Status Bar 66 for the focus vehicle, including Competitor Grid 68 and a link to View-Supply Trend 70 (see FIG. 4 for the Radar Detail); and the Competitive Set 40.

The Competitive Set 40 will display relevant descriptions, by row, of the vehicles ranked as the focus vehicle's competitors. The Competitive Set 40 is listed by Value Ranking 38, from lowest to highest. The Radar View 60 will display at least 10 competitive vehicles at a time. The user will be able to scroll down to view more competitors as needed. The focus vehicle (72 in FIG. 3) is contained in a row of its own and is shaded to denote that it is the focus vehicle, as well as being displayed on the Status Bar 66. From this list the user can verify a competitive vehicle's relevance by “seeing” its description 74 and a photo 76 of the vehicle, as the cursor moves across a row. These details will populate “dialog-type” boxes above the list.

In addition to providing detailed information about a competitor, each row contains a Confirmation/Exclusion field 78. A vehicle can be excluded from the competitive analysis should a user decide that it is not relevant for the purposes of considering price 14 or Value Ranking 38. An Excluded Vehicle 78 will no longer be ranked and will no longer affect the competitive position of the focus vehicle 72. The excluded vehicle 78 will drop to the bottom of the list of competitors and will be shaded in gray to indicate that it has been excluded from the competitive set 40. At any time, a user can update the Confirmation/Exclusion 78 field to “re-include” a vehicle. All relevant values will update accordingly.

When the user opens the application or system at a later date or time, the Radar Link 44 will prompt the user to either “Continue” directly to the Radar View 60, or to “View New Competitors” 80 (see FIG. 5B for the Radar Link Drop-Down). If the user chooses to “Continue” 82 directly to the Radar View 60, new competitors will be included in the Competitive Set 40, according to their Value Rankings 38. The confirm/exclude icon 78 will be shaded orange to indicate that the user has not yet evaluated the vehicle.

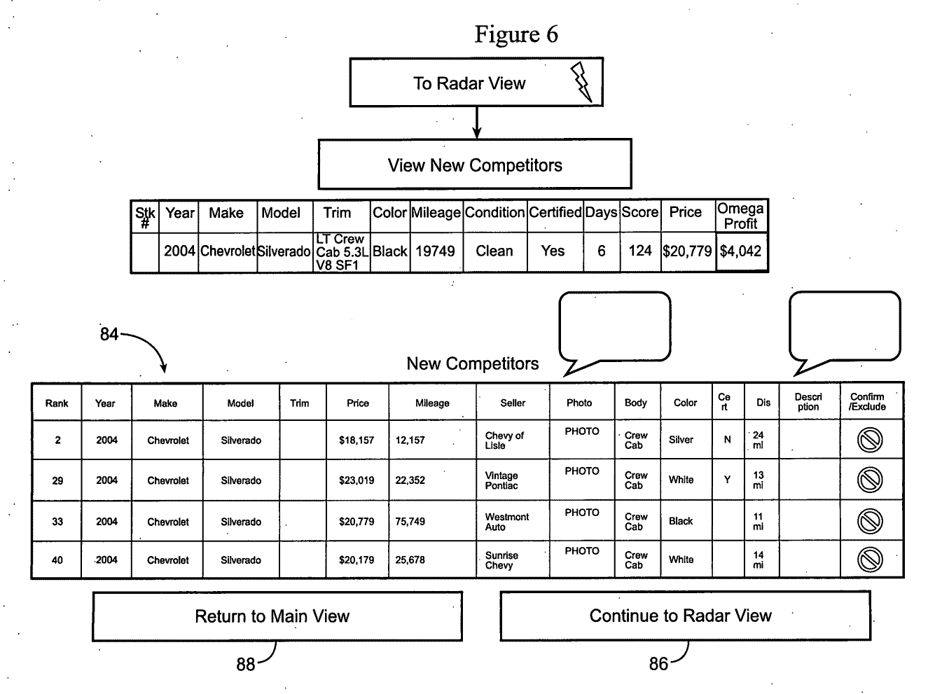

If the user accepts the prompt to “View New Competitors” 80, the user will be directed to the New Competitor View screen 84 which displays only those competitive vehicles that have not been previously viewed by a user and, consequently, have neither been confirmed or excluded from the analysis. FIG. 6 shows the New Competitor View screen 84. This new competitor feature allows a user to immediately update the list of “included” versus “excluded” competitors. Should the user decide to exclude a vehicle, as previously described, this vehicle will be highlighted in gray and moved to the bottom of the competitive list. To the extent that a vehicle has been excluded from the analysis, it will remain excluded should the application be refreshed or used again at a different time.

Once a user has finished evaluating the New Competitors, the user can select the “Continue to the Radar View” button 86 or “Return to the Main View” 88.

As on the Main View 10, the user can also model Price 14, Omega Profit 36, and Value Ranking 38 on the Radar View 60 and all dependent variables will dynamically update. This is done from the Status Bar 66, the Competitive Set Bar 62 and the Omega Profit Bar 64, and not from the Competitive Set 40. The list of competitors is only interactive with respect to including or excluding vehicles. Consistent with the functionality of the Main View 10, the user can override a Default Competitive Set Profile and/or a Default Omega Profit Profile from the Radar View 60, and the screen will repopulate with the appropriate list of competitors. Changes will not be saved until the user clicks the SAVE button 90, as described in detail herein. This functionality allows the user to model various pricing scenarios. The user will be prompted to SAVE 90 or UNDO 92 changes made before working on another vehicle or exiting the application.

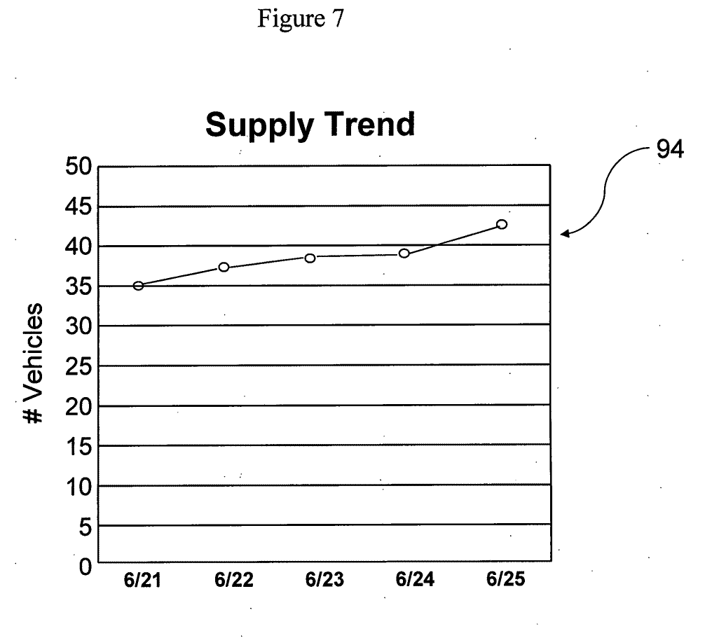

The Status Bar 66 on the Radar View 60 also provides a View Supply Trend link 70 to a Supply Trend Graph 94 that shows how the Competitive Set 40 size is changing over time. FIG. 7 shows an example of a Supply Trend graph 94. The Radar Application needs to automatically store the data needed to generate this graph 94, using daily values. The graph 94 should plot the total competitive set 40, before exclusions, for consistency.

The Radar View 60 can be sorted in the same manner as other data screens, and can be printed.

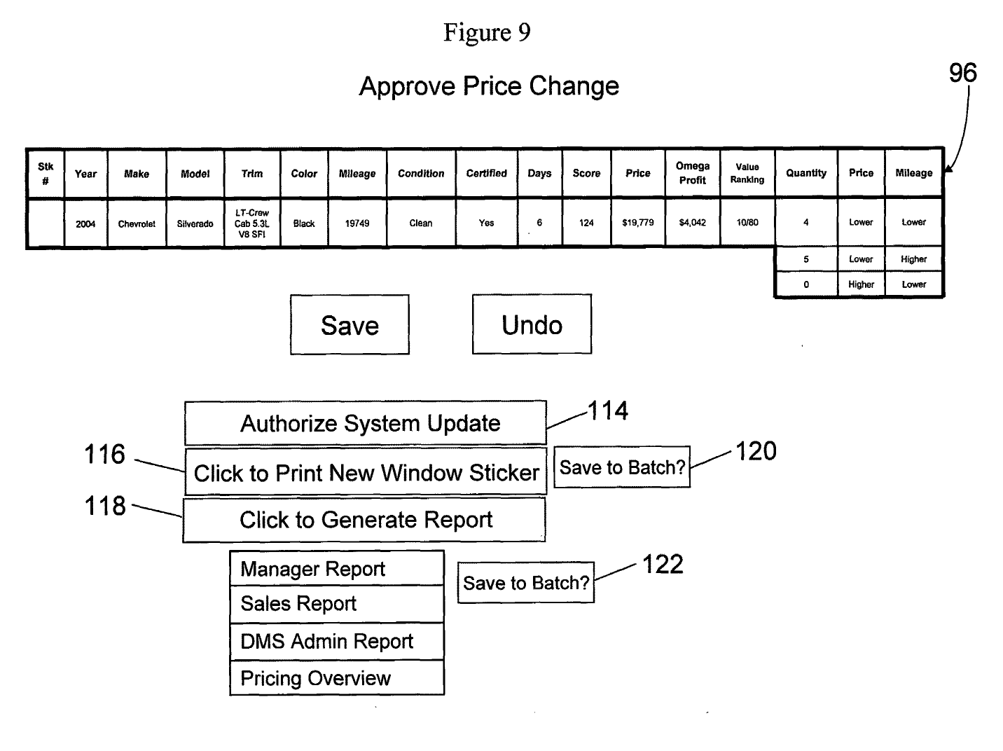

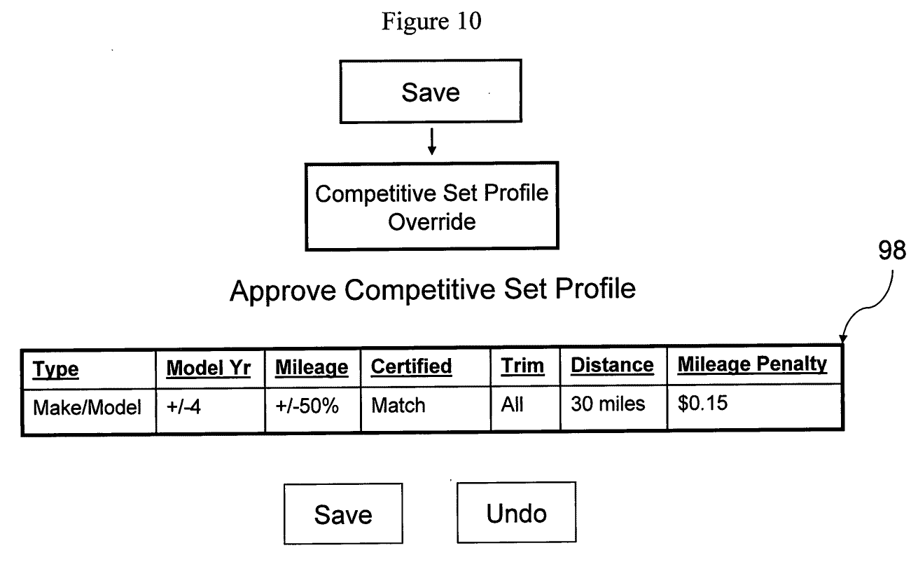

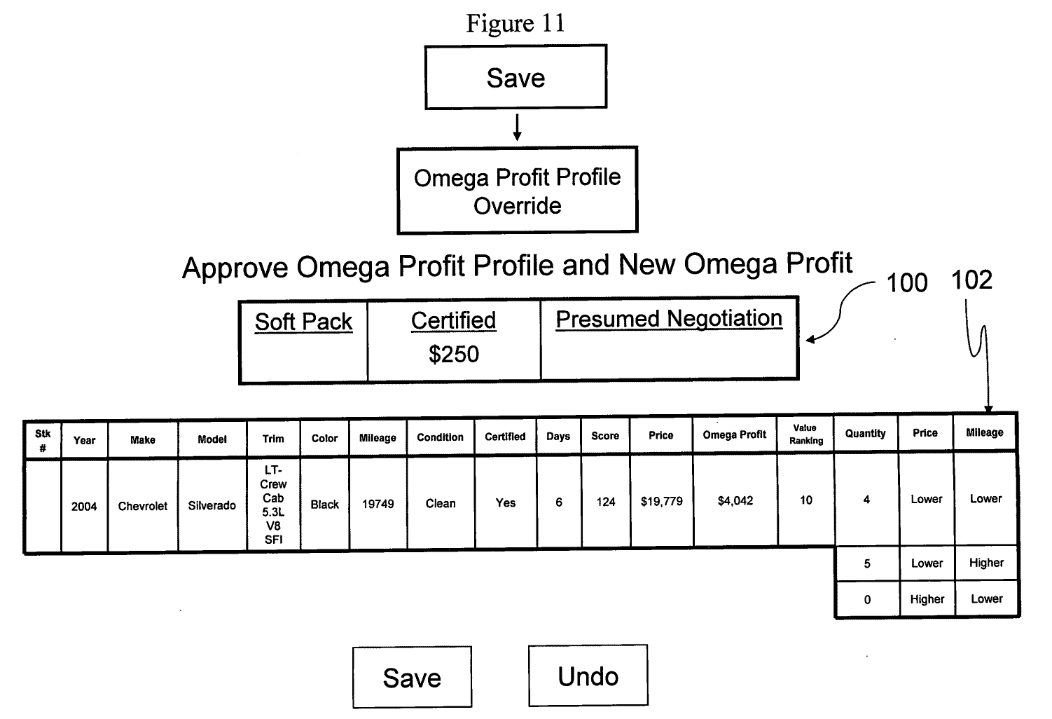

### The Save Feature

Wherever the user has the ability to model price 14 or override the Default Competitive Set Profile or Default Omega Profit Profile, there will be both a SAVE and an UNDO prompt. There is a unique visual recap for saving each type of change. Should a user wish to SAVE more than one type of change, for example, a Price 14 and a new Competitive Set Profile 40 or a Price 14 and a new Omega Profit Profile 36, the user will receive a visual recap for each change. Specifically, FIG. 9 shows a price change 14, where the user is asked to verify the new Status Bar 96. FIG. 10 shows that for a Competitive Set Profile 40 change, the user is asked to verify the new Competitive Set Bar 98. And FIG. 11 shows that for an Omega Profit Profile 36 change, both the new Omega Profit Bar 100 and the new Status Bar 102 (showing the new Omega Profit) must be verified by the user.

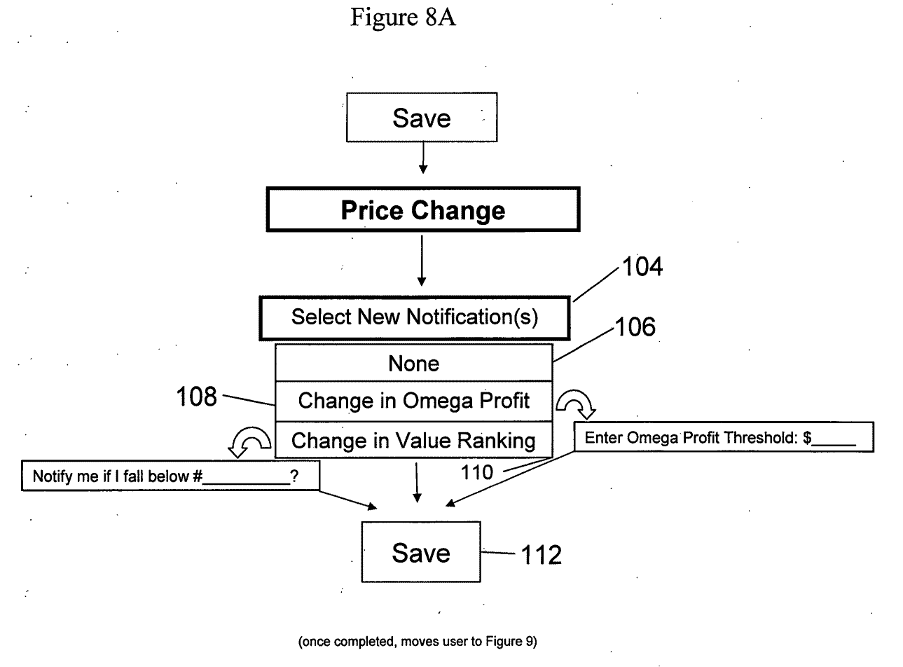

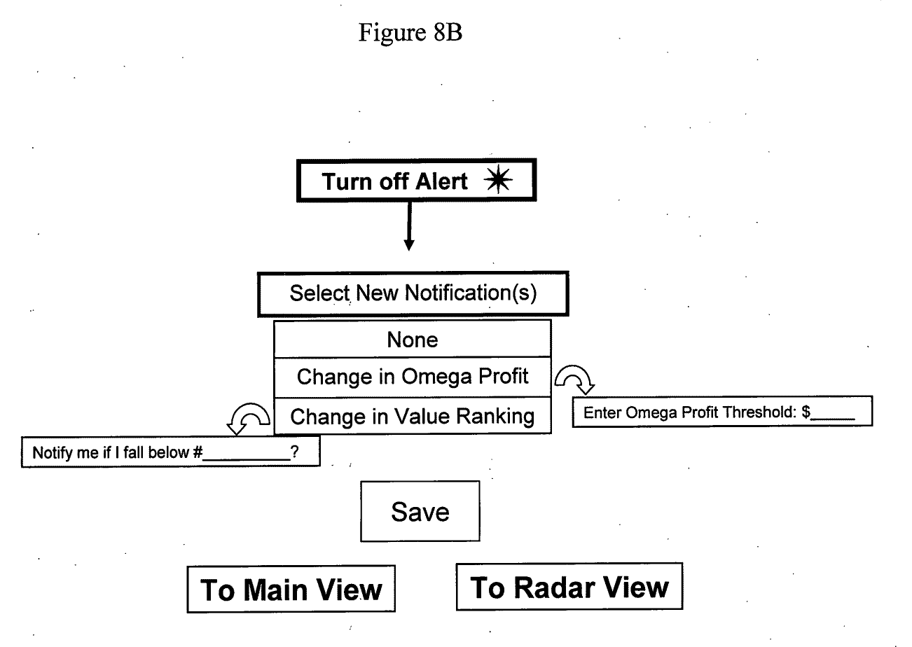

Before any change that affects Price can be SAVED, Vehicle Notification Options 104 will first be offered. These options will be presented in a series of drop-down boxes. FIG. 8 shows the Vehicle Notification Drop-Downs 106-110. A user can select “no notification” 106, an Omega Profit 108, and/or a Value Ranking notification option 110. The Vehicle Notification is in addition to, and not instead of, the Global Default Notification installed during the set-up/configuration of the application. After selecting a Vehicle Notification 104, the user will be directed to the SAVE feature 112 for Price Changes 96, as described above and shown in FIG. 9.

After the Vehicle Notification 104 options and price verification 96, the user will be prompted to update the system 114 for all price changes. When the user saves a price, they will have the option to designate one or more systems to update. The logins and passwords for these systems would be entered and saved by the users as part of the installation and set/up configuration procedure. The Radar Application is configured to send an automated message to a cost-effective, outsourced, labor center in order to generate the update as part of the SAVE function.

Additionally, as shown in FIG. 9, users will have the option to generate a new window sticker 116 reflecting the pricing change, and/or to generate any relevant reports 118. If a user is updating more than one vehicle, the user can request that the window sticker and/or report save to batch 120, 122 for later printing.

### The Reports Feature

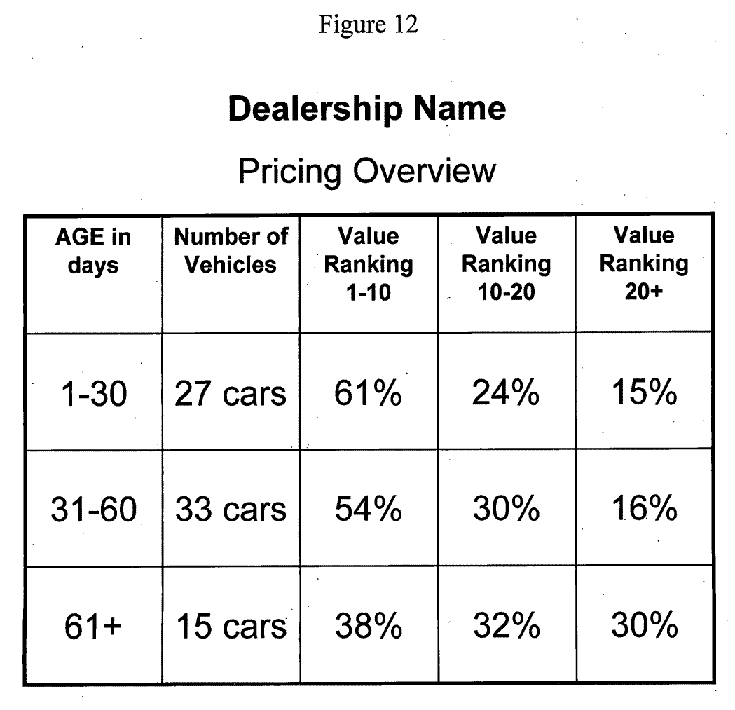

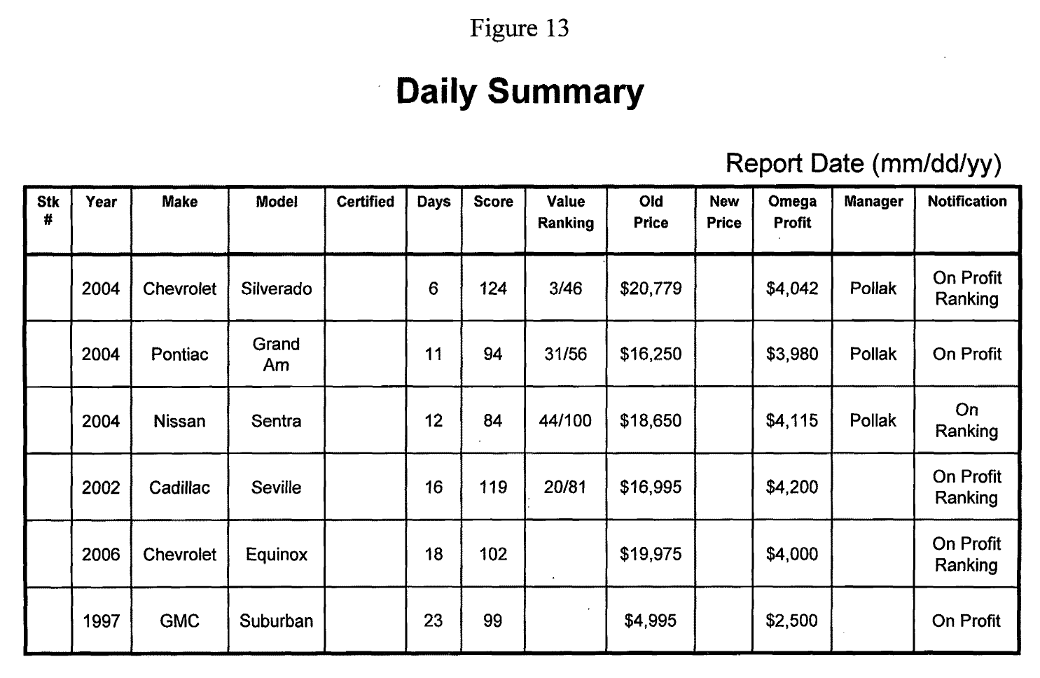

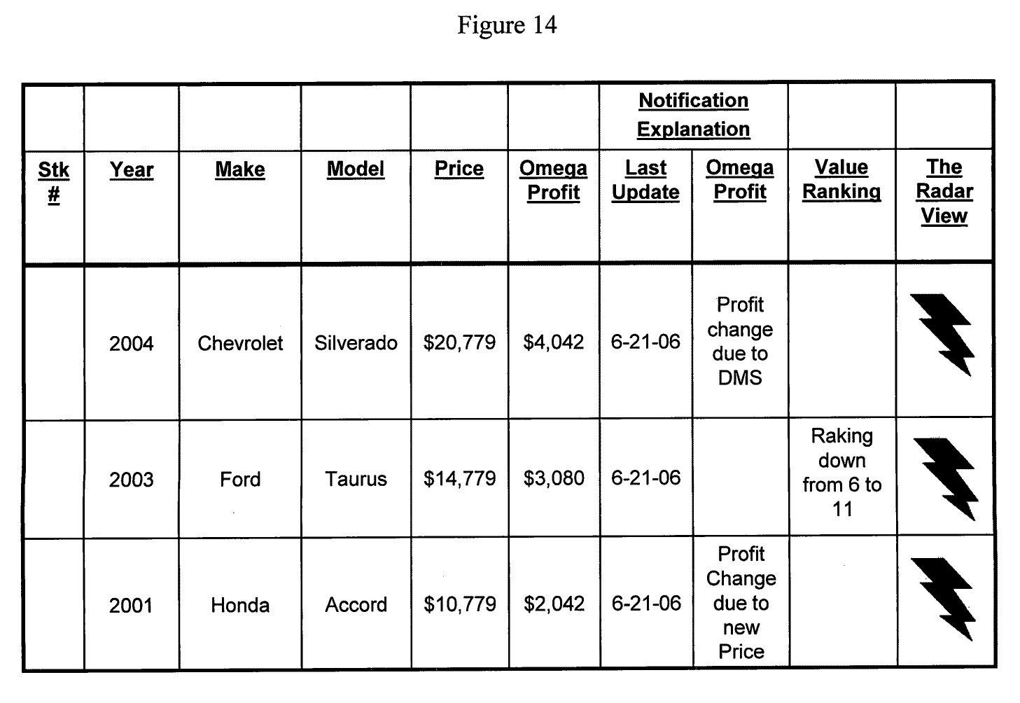

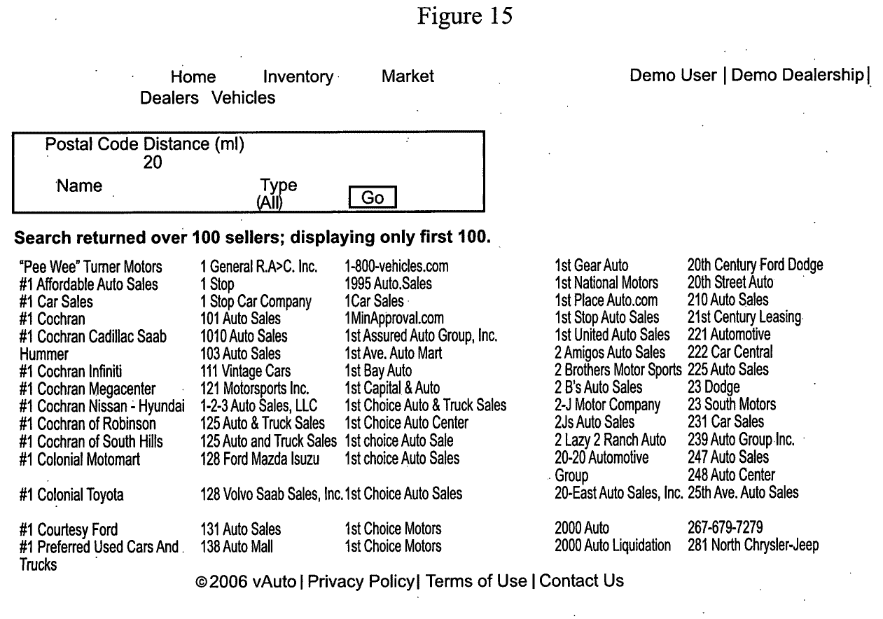

The Radar Application will be able to generate a variety of reports, including by way of example, Dealership Pricing Overview Report as shown in FIG. 12, a Daily Summary of Pricing Adjustments (by date) as shown in FIG. 13, a Yellow Car Report as shown in FIG. 14, a Dealers' Report as shown in FIG. 15, a Managers Report (not shown) and a Salesperson Report (not shown).

The Radar Application can also be accessed from the mPower Auto Appraisal Screen in order for a manager of the dealership to view the competitive environment prior to completing the appraisal process. In this instance, the manager could view competitor's prices listed by Value Ranking 38 to help ascertain the appropriate value for optimal sale.

### The Radar Application

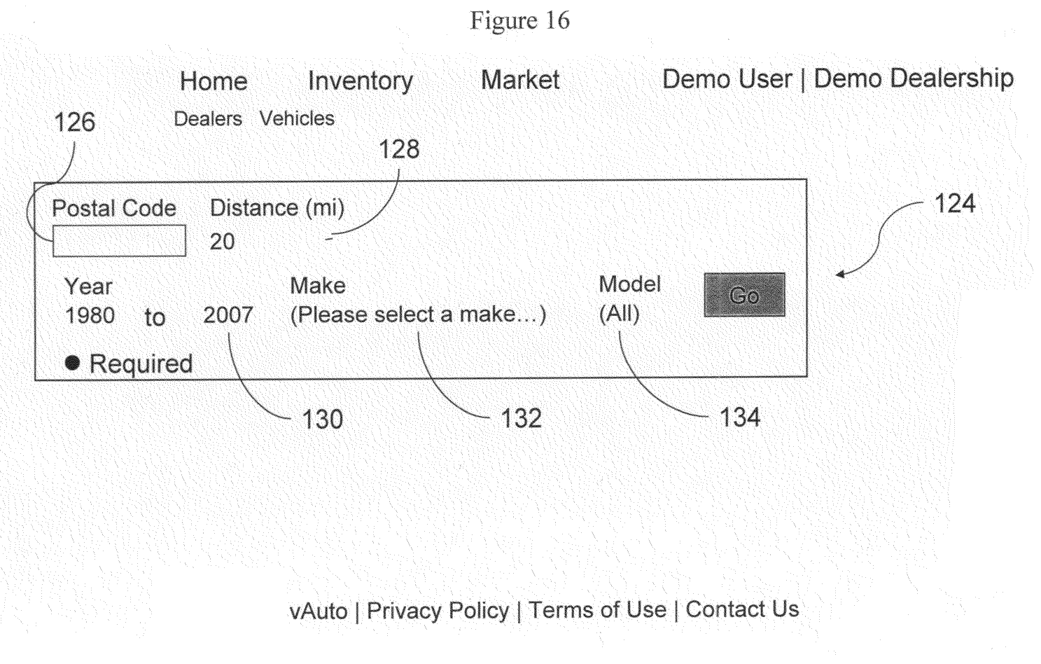

As shown in FIG. 16, once the system is populated with the necessary information using the harvesting technology described herein, the user can begin by accessing the Market Vehicles page 124. The user enters the postal code or zip code of the dealership 126, the distance from the dealership for the search 128, the year 130, make 132, and model 134 for the search.

Once this information is entered, the system will pull up a default configuration for the particular vehicle and establish a Value Ranking and an Effective Value Ranking for the dealer's vehicles in inventory. These rankings are based on similar vehicles, using the default configuration, however, the user can change the configuration, i.e., the engine type, trim, series, etc., in order to include or exclude certain vehicles from the ranking. This revised configuration can be done dynamically to show how differing the configuration varies the ranking. Further, these revisions can be stored and saved by the system so that at some point, the system will automatically change the default to match the most widely used configuration, or the competitive set.

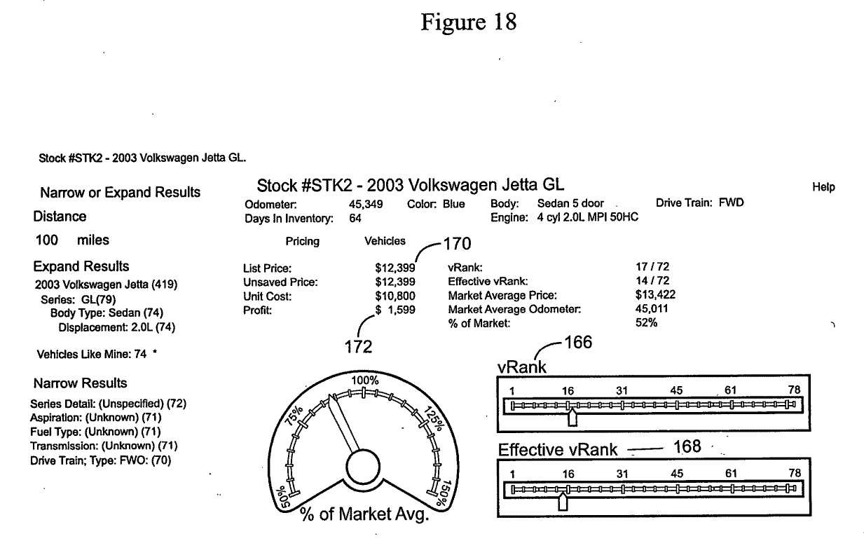

The Value Ranking 160 is determined by comparing the search results for all the vehicles for sale in the configuration. Once this information is obtained, the price of the focus vehicle is compared to all of the same vehicles in the search results and a number, based on price alone is generated. For example, as shown in FIG. 18, if 72 vehicles match the search, and 16 are priced lower and 55 are priced higher, the Value Ranking will be 17/72.

The Effective Value Ranking 162 is determined by taking into account the mileage each vehicle has and normalizing the price based on those miles. In other words, each vehicle is penalized for the miles is has been driven. However, a number of variables may be used to generate an Effective Value Ranking; for example, the condition of the car, standard and non-standard options, driving history, geographic location of car, whether or not garage kept, etc., can be taken into account when normalizing the vehicles.

Once each vehicle is normalized for miles (in this example), a new ranking, the Effective Value Ranking is established. In this example, if there were three vehicles with extremely high mileage, their Effective Value Ranking would drop when the normalization calculation took place. Thus, the focus vehicle would move from a Value Ranking of 17/72 to an Effective Value Ranking of 14/72 (see FIG. 18).

Also, a Value Score could be created based on the percentage of the asking price based on the mean of the Effective Value Ranking. So for example, if the mean effective asking price was $13,422 and the dealer or user was asking $12,399 for the vehicle, the Value Score would be 92% (see FIG. 18).

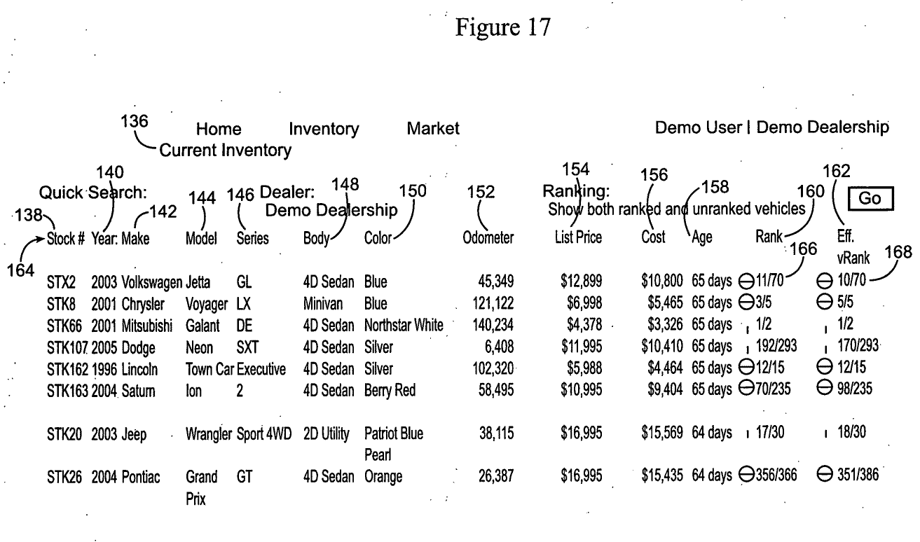

Once these calculations are complete, the user then can review a list of the dealership's current inventory 136, as shown in FIG. 17. The report displays all of the characteristics for each of these vehicles, including the stock number 138, the year manufactured 140, the make 142, the model 144, the series 146, the body type 148, the color 150, the mileage 152, the list price 154, the cost of the vehicle to the dealer 156 and the number of days on the lot 158.

The cost to market is the ratio of a dealership's unit cost compared to the average market retail price of a comparably equipped year, make, and model vehicle. It is calculated both on a per car basis and in aggregate.

The report also includes the Value Ranking 160 and the Effective Value Ranking 162. As described above, the Value Ranking 160 and the Effective Value Ranking 162 are determined from the results of the search of used vehicles (within the radius determined by the dealer). The rankings are based on price and mileage of the used vehicles for sale.

In the example on FIG. 17, the information pertaining to focus vehicle Stock No. 2 164 is listed in the first row. Stock No. 2 is a blue, four-door, 2003 Volkswagen Jetta GL with 45,349 miles. The vehicle is currently listed for sale a $12,399, cost the dealer $10,800, and has been sitting on the lot for 65 days. The system uses this information, along with the information obtained through its internet harvesting to determine that the Jetta's Value Ranking is 14/70 166. In other words, of the 70 Jettas being sold in the area, this particular Jetta has a Value Ranking of 14, based on price and mileage. Further, the Effective Value Ranking is 10/70 168.

FIG. 18 shows the display when the dealer selects the particular stock number, in this case Stock No. 2 164. The display shows all of the information from the previous inventory page, including the Value Ranking 166 and the Effective Value Ranking 168, however, the user can revise the selling price 170 of the vehicle and immediately obtain revised rankings. The system also calculates the profit as it is revised based on the selling price so that the dealer can take the changing profit 172 into account. This dynamic response allows the dealer to revise the selling price of the vehicle in response to other similar vehicles for sale to obtain the optimal selling price at the optimal profit margin.

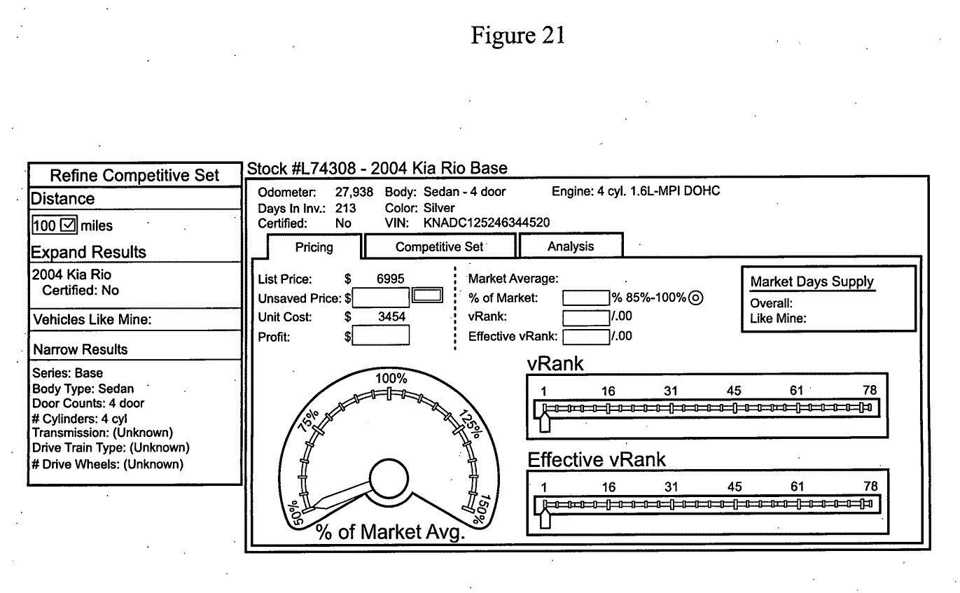

Further, FIG. 21 shows another embodiment of the present invention, the functionality called “vMax,” that automatically maximizes the asking price based on any selected “effective vRank” or “vRank”. The vMax functionality finds the highest possible price while maintaining a pre-selected market rank position, i.e., vRank 166 or effective vRank 168. A user can use the vMax functionality to determine the optimal price for a given vehicle, recognizing its current market position with respect to its competitors, and the strategic value of that position. The user has the ability to have the vMax functionality automatically set prices for its used inventory, thereby, serving as the foundation for developing, setting and implementing internal and/or an internet pricing strategies for at least one used vehicle in inventory.

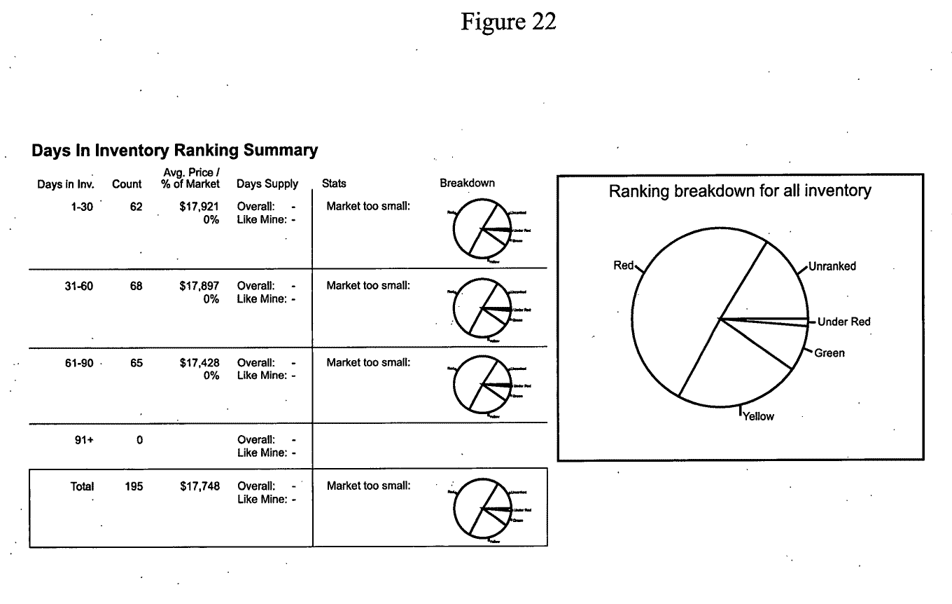

FIG. 22 shows a report for the “Days in Inventory Ranking Summary.” This report includes chart and pie formats to demonstrate the number of days that automobiles are in the inventory.

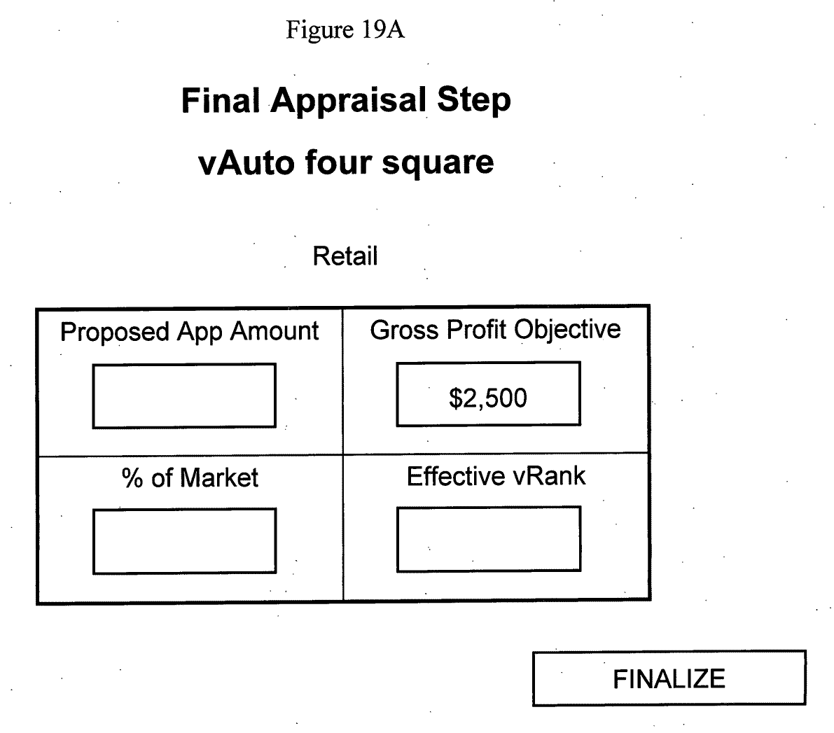

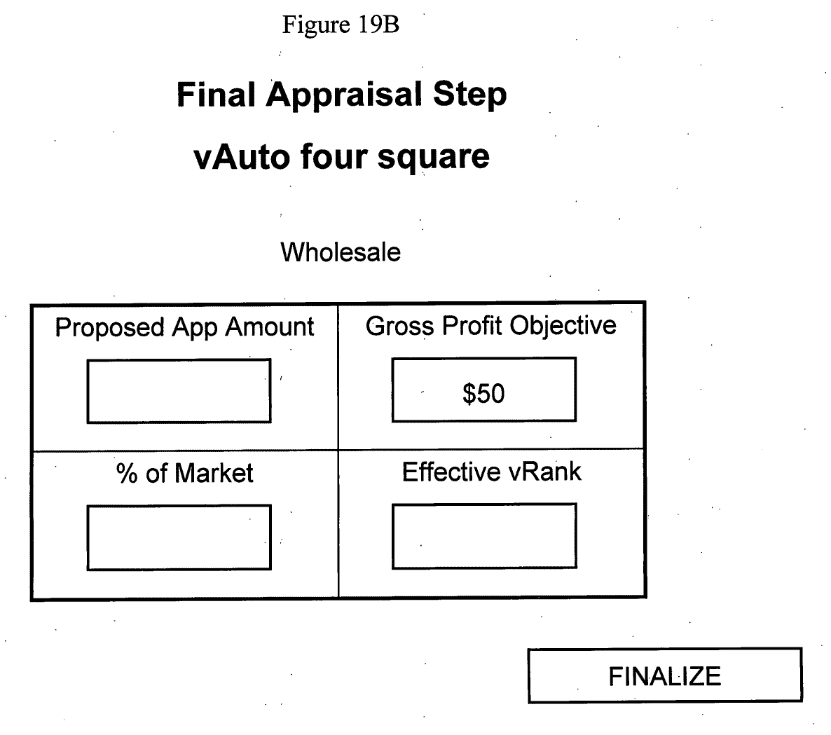

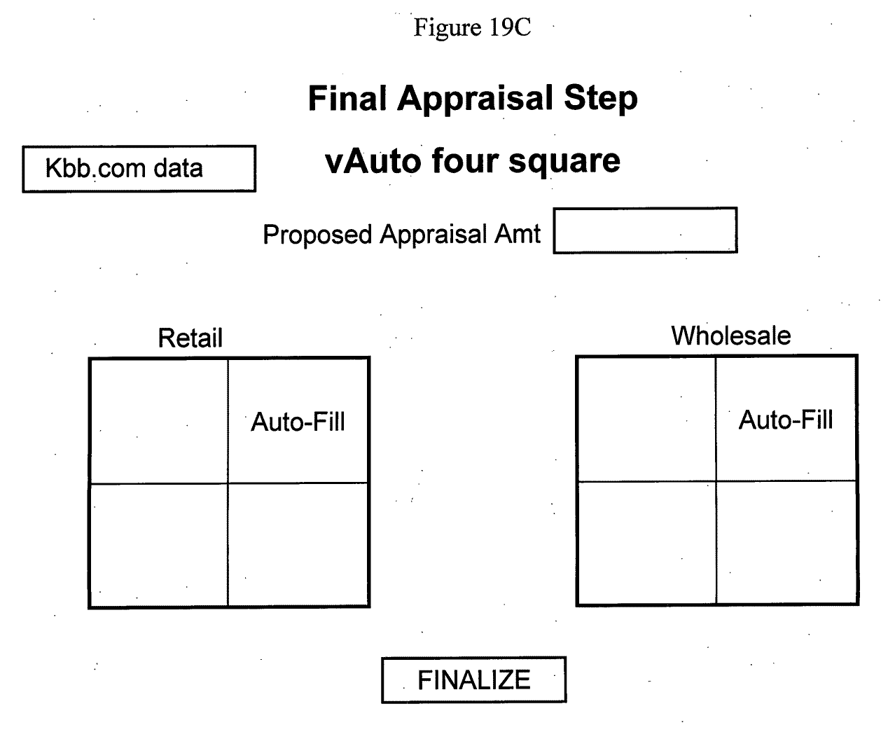

FIG. 19A-C shows another method for assessing the relationship between the proposed acquisition amount, the dealership's goals and the present retail market/wholesale market. This method, the VAuto Four Square, allows a user to insert and/or change variables and thereby dynamically recalculate the remaining variables (in this case, the remaining three variables).

Although numerous variables are contemplated for this method, some of the examples include the proposed appraisal amount, the target gross profit, the percentage of market and the effective vRank. The default profile includes those vehicle attributes that are pre-selected by the system for determining the competitive set as described above.

By changing some or all of these variables, the user is then presented with the dynamic results after recalculation. FIG. 19A shows a retail calculation for the VAuto Four Square method for variables including the proposed appraisal amount, the percentage of market, the effective VRank and the gross profit objective. For example, as the user changes the gross profit objective, the other variables will be recalculated. FIG. 19B shows the same variables, but for a wholesale transaction having a lower gross profit objective. FIG. 19C provides similar information, but displays the dynamic variables while also comparing the retail and wholesale markets.

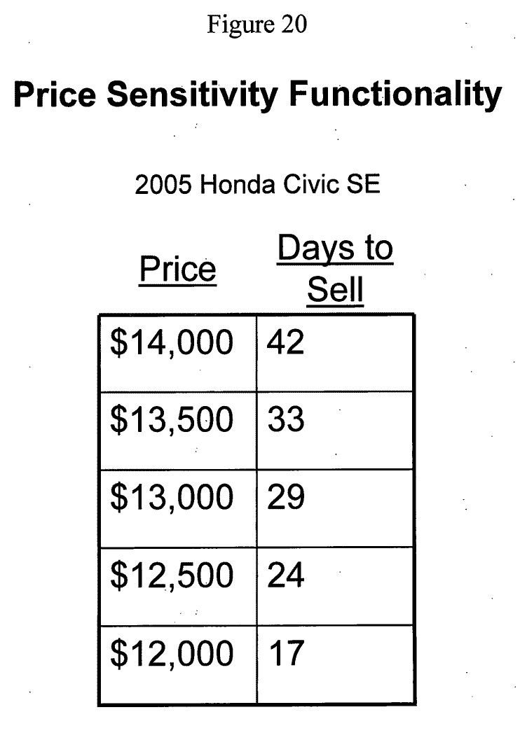

As shown in FIG. 20, for a uniquely configured vehicle, a user has the ability to input at least one price and dynamically obtain the number of “days to sell” for that vehicle at that given price.

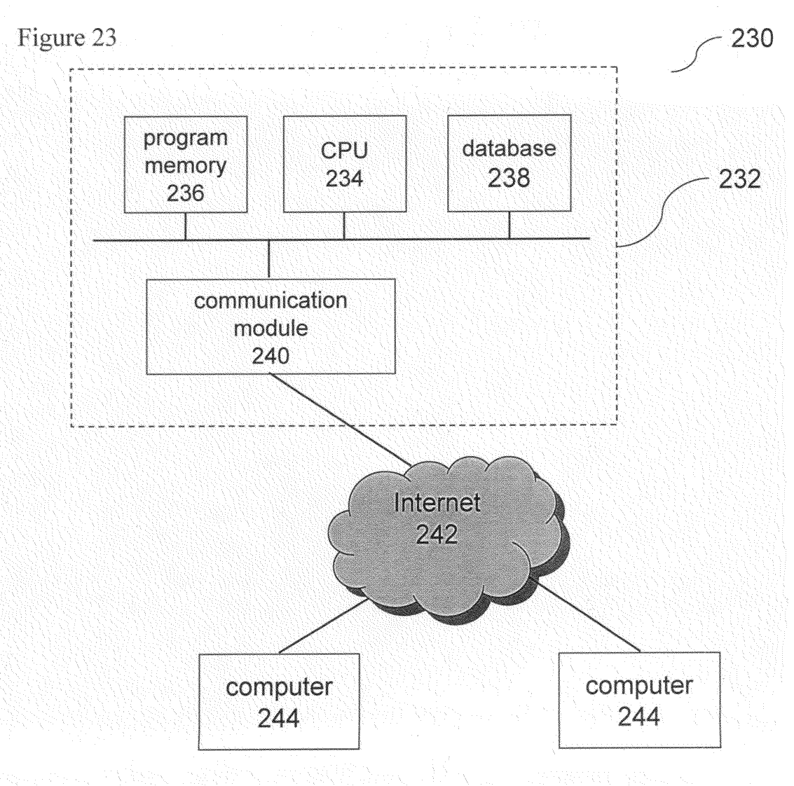

FIG. 23 is a schematic diagram of the present invention showing a system 230 in which a host computer 232 houses a CPU 234, a memory 236 and a database 238. The system also contains a communication module 240 which can access and communicate with a global communication network, such as the Internet 242. Other types of communication networks will also suffice, such as an Intranet, a Wi-Fi, Wimax, cellular or other networks.

In the program memory 236 is the application software to run the present invention and allow users, or dealers, to access the applications through the Internet 242 using their remote computers 244.

At the outset, the host computer 232 (or another computer), using harvesting technology, obtains information pertaining to various automobiles for sale. This information is parsed to obtain the descriptions of the automobiles, mapped, normalized to various descriptors, and stored in the database 238. The database may be located in the host computer 232, or may be on another computer or at a remote site. The information necessary to populate the database 238 is always changing and thus must be updated continuously.

Once data is harvested and normalized, the present invention allows for the creation of a new retail pricing guide book based on live market date, known as the rbook. The rbook is available through the appraisal tool as a source of additional data on current market pricing. It allows users to select specific trim and features which result in the elimination of similar vehicles that do not match the exact configuration of the vehicle under evaluation. The system therefore profiles the quantity, average retail price, and mileage of comparably equipped vehicles in the designated market area.

FIGS. 24 through 31 show the present invention integrated as one application to provide all the functionality described herein. Although integration is not necessary, there are numerous advantages to integrating the various applications.

As described herein, the system harvests information pertaining to automobiles for sale and parses out the description of those automobiles in order to normalize to a particular descriptor. For example, one automobile may describe a NAV system, while another may indicate a GPS device. The present invention normalizes these descriptions to a particular descriptor, i.e, a navigational system.

Once the information is harvested (on a continuing basis), the present invention can display this information along with the dealer's inventory information in a number of ways.

FIG. 24 shows the main page of the pricing tool 250. With this snapshot, the dealer can obtain numerous summaries of inventory. The inventory can be ranked by age group 252, ranking totals 254, and a summary of the days the vehicles have been in the inventory 256. The summary can also indicate total investment 258, average investment 260, among other information. Also, the dealer can receive information about automobiles that are slow moving or need attention 262, i.e., revised selling price, etc. Additional tabs allow the dealer to obtain more information about the inventory. The Investment Summary tab 264 and Appraisal Summary tab 266 take the dealer to additional screens for more detailed information.

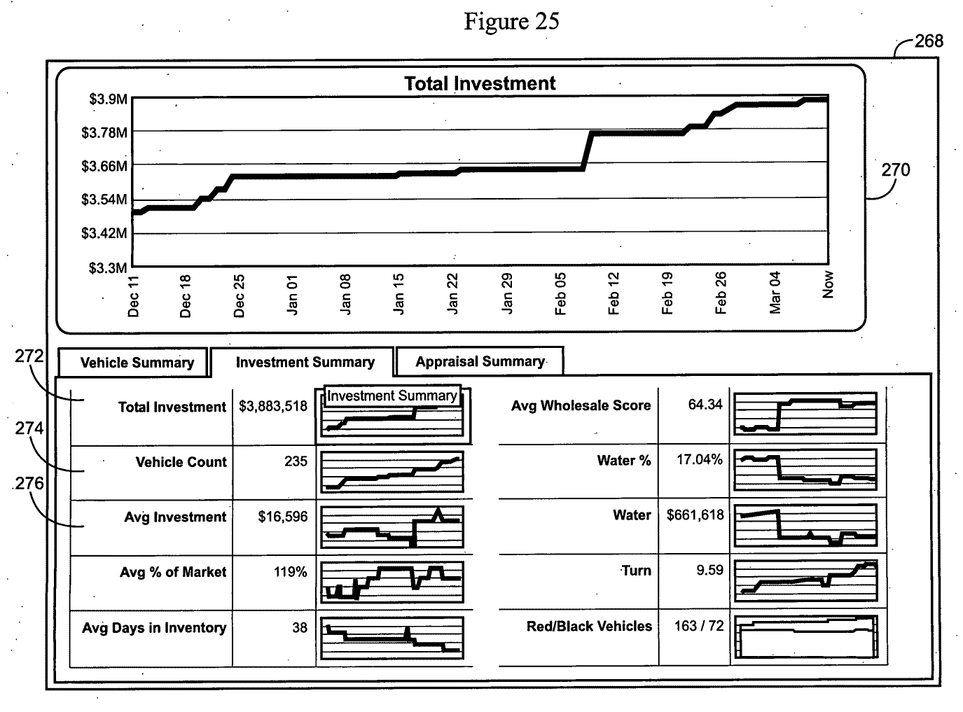

FIG. 25, the Investment Summary 268, is displayed when the Investment Summary tab 264 is selected. The Investment Summary 268 indicates the dealer's total investment 270, based on all vehicles in inventory (or a subsection of those vehicles, if not all are selected). Additional information is displayed in chart form; however, the information can be displayed in any manner. These charts include total investment 272, vehicles count 274, average investment 276, among others. Any information pertaining to the dealer's inventory investment can be displayed here.

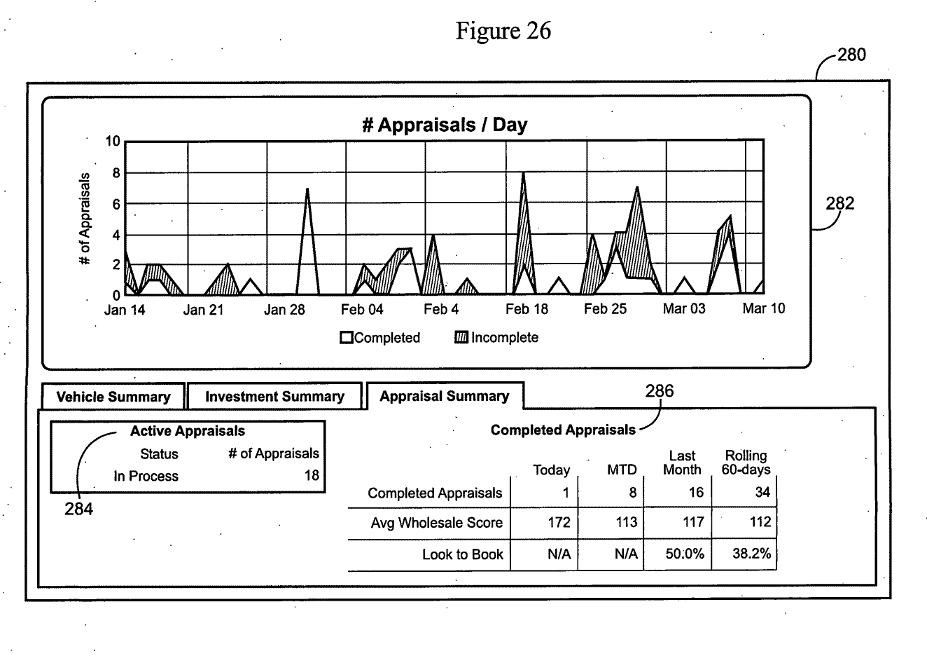

If the dealer selects the Appraisal Summary tab 266, the Appraisal Summary Screen 280 in FIG. 26 will be displayed. The Appraisal Summary Screen 280 indicates a chart of the number of appraisals per day 282, along with information pertaining to the active appraisals 284 and the completed appraisals 286. As shown in FIG. 26, the completed appraisals can be broken down further into categories.

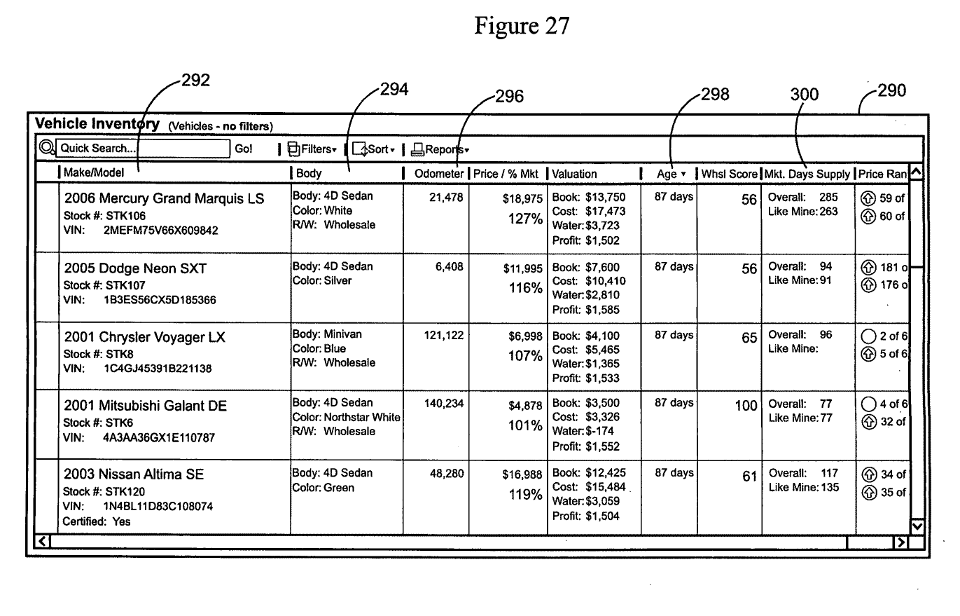

FIG. 27 shows a breakdown of the dealer's inventory 290 by each automobile. The screen displays the make, model and year 292 of each automobile along with body trim 294, mileage 296 and various other information pertaining to the inventory. The dealer can also quickly see how long each vehicle has been in inventory 298 and a comparison of days in inventory to various markets 300. The inventory screen also shows the price rank 302 for each automobile. Additional information about each automobile may be disclosed.

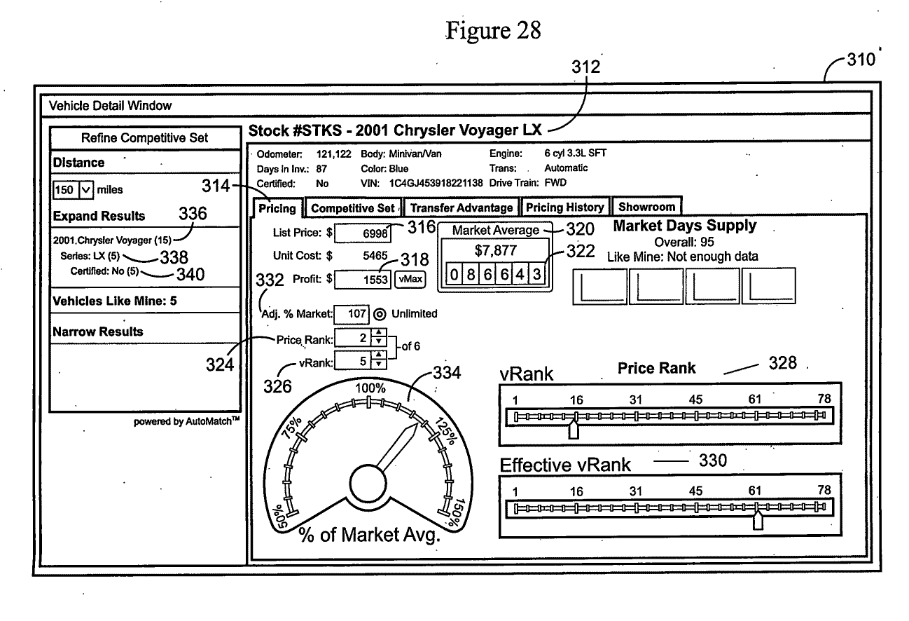

FIG. 28 shows a particular automobile's information on a Vehicle Detail Window 310. This window 310 provides the dealer with a dynamic tool for changing the selling price to optimize the sale.

The window 310 indicates the details pertaining to the particular automobile 312, in this case a 2001 Chrysler Voyager LX. Once the pricing tab 314 is selected, the display indicates the list price 316, profit at that price 318, market average 320, mileage 322, price rank 324 and vRank 326, among other information. The display also indicates the Price Rank and vRank slider bars 328, 330, in this case, from one to six. The adjusted percentage of Market is shown as a number 332 and as a dial indicator 334.

Also displayed for the user is information pertaining to the number of other 2001 Chrysler Voyagers in the sample 336, in this case 15, the number of LX's 338, five, and the number of vehicles certified 340, also five. Other information includes Market Days Supply and information about the vehicle. More or less information may be included.

As described herein, the present invention is both integrated across the different applications, and dynamic insofar as updating the system automatically upon revisions.

FIG. 28 also shows that much of the information pertaining to the focus vehicle, in this case, the 2001 Chrysler Voyager LX, can be modified in order to revise various outcomes, including Price Rank 324, 328, vRank 326, 330, profit 318, etc. Further, the Competitive Set can be narrowed or broadened and doing so will revise the outcome.

For example, if the dealer wants to move the vRank 326, 330 for this vehicle from 5 (currently) to 2, he can enter the number 2 into the box 326 or move the slider 330 from 5 to 2. The system will automatically revise the list price 316 (downward) to obtain a vRank 326, 330 of 2. In turn, the profit 318 will also be reduced and the adjusted percent of market 332 will change accordingly.

Also, the dealer can revise the Competitive Set to include non-LX Chrysler Voyagers, for example. Now, the Competitive Set will include 15 models 336, not 5 338. The Market Average 320 price the mileage 322 will be revised based on the new Competitive Set. Although there will now be 16 vehicles in the Price Rank 324, 328 and vRank 326, 330 (15 vehicles from the Competitive Set and the focus vehicle), the Price Rank 324, 328 and vRank 326, 330 will be revised dynamically. Most of this information can be revised dynamically to obtain new results.

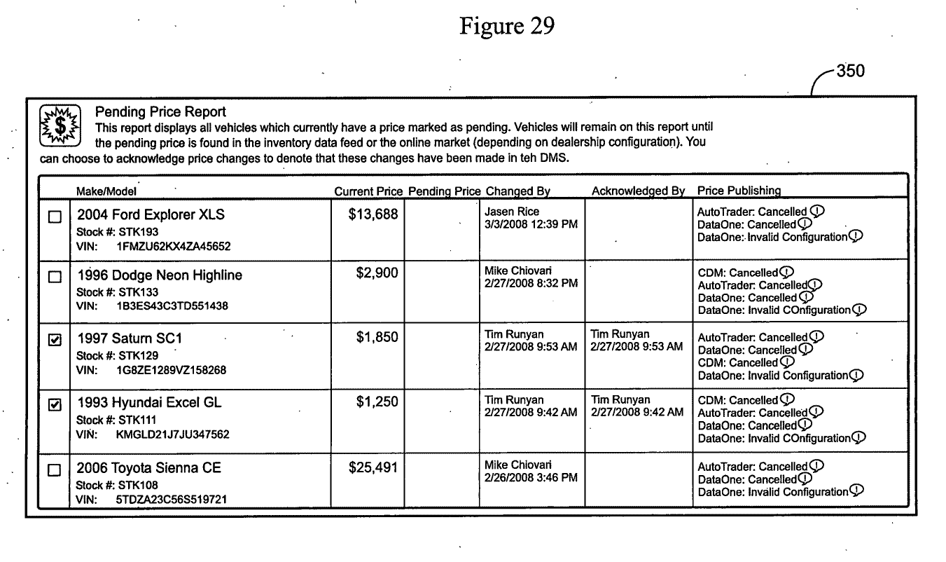

FIG. 29 shows a Pending Price Report 350, which displays all of the vehicles that have a price marked as pending. The dealer has the ability to acknowledge the price change or denote that the changes have been made.

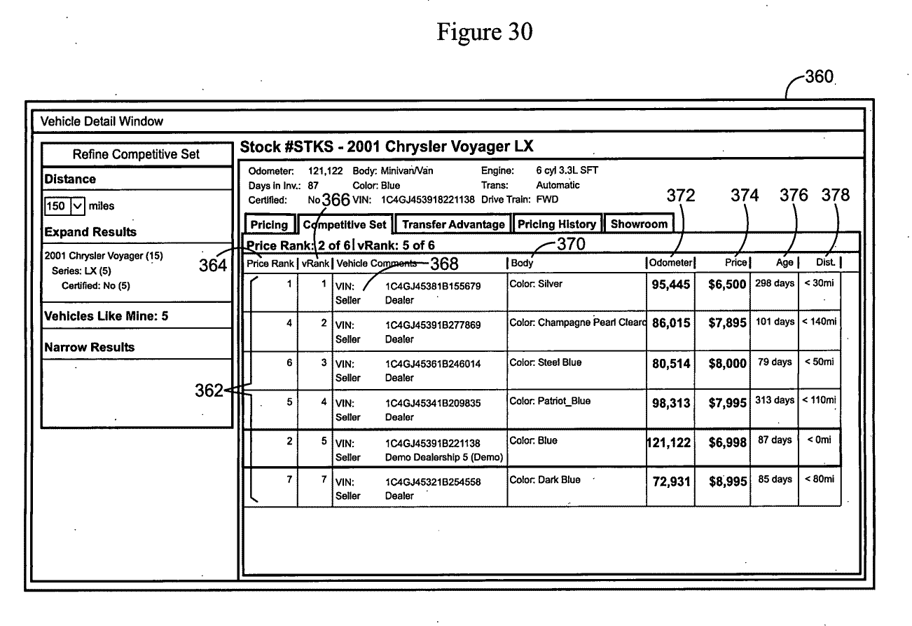

FIG. 30 displays the Competitive Set 360 for the same 2001 Chrysler Voyager LX. This screen is displayed when the Competitive Set radial button is selected from FIG. 28. FIG. 30 shows each of the 2001 Chrysler Voyager LX vehicles that were used to generate the focus vehicle's price rank and vRank. Each of the vehicles is displayed in a separate row 362, along with its Price Rank 364 and vRank 366. Also shown are the Vehicle Identification Number or VIN 368, information about the body 370, the mileage 372, price 374, Age or days for sale 376, and the distance the automobile is located from the dealer 378. Again, more or less information can be displayed here as needed.

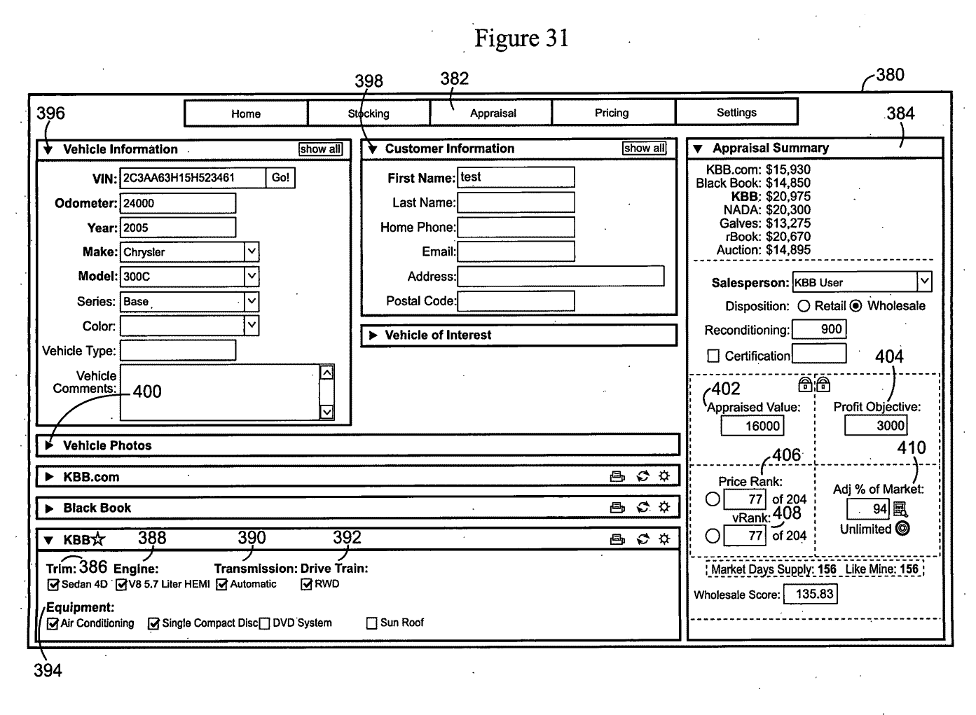

FIG. 31 shows the Appraisal Window 380, which is accessed by selecting the Appraisal radial button 382 throughout the program. Since the applications are integrated, the Appraisal window 380 can be accessed from multiple locations. Once in the Appraisal window 380, the dealer can enter or modify information 396 about the focus vehicle to find the optimal selling price for the focus vehicle. The Appraisal summary 384 indicates the pricing of the particular vehicle from a number of sources, as describe above. Further, the dealer can change the information about the particular vehicle, such as trim 386, engine 388, transmission 390, drive train 392, and equipment 394, among others.

The dealer can also enter customer information 398 as necessary. Also, the Appraisal screen 380 can allow the dealer to see Vehicle Photos 400.

As described above, the Four Square functionality allows the dealer to dynamically change one of the following: Appraised Value 402, Profit Objective 404, Price Rank 406, vRank 408 or Adjusted Percentage of Market 410, by revising the other values. For example, by revising the Appraised Value 402 downward, the Profit objective 404 will reduce, however, the Price Rank 406 and vRank 408 will improve. These values and others can be used in this Four Square functionality to obtain the optimal price.

Since this system is integrated, making changes in the Appraisal Window 380 will modify the values in other windows when later viewed.

The present invention also includes a stocking tool which calculates and then generates a variety of lists of top selling vehicles dependent upon sorting criteria. These lists can be generated and sorted based on a number of variables, including but not limited to market days supply, available vehicles, and sales rates data over any specified number of days. The lists are created at various levels of detail, including vehicle type and class, year, make, model, and trim specification.

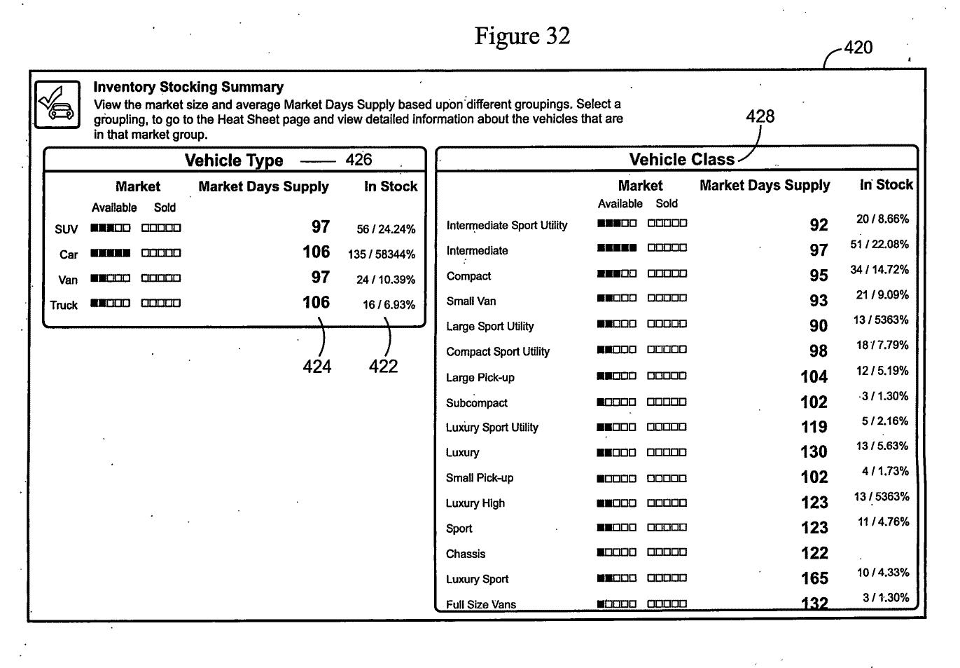

FIGS. 32 through 35 show the stocking tool results as displayed on the screen.

FIG. 32 is an Inventory Stocking Summary window 420. The window 420 shows the market size 422 and average market days supply 424, for Vehicle Type 426 and Vehicle Class 428.

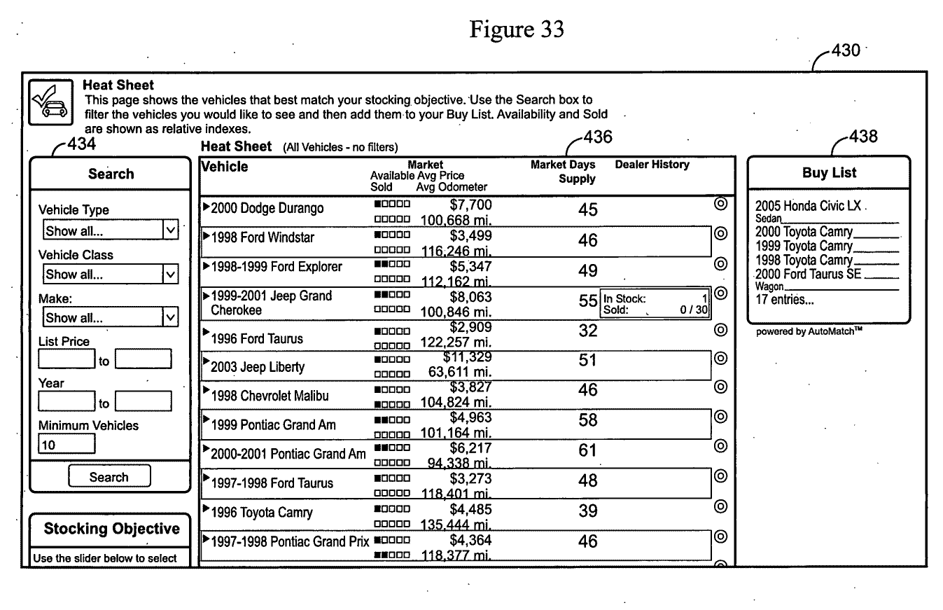

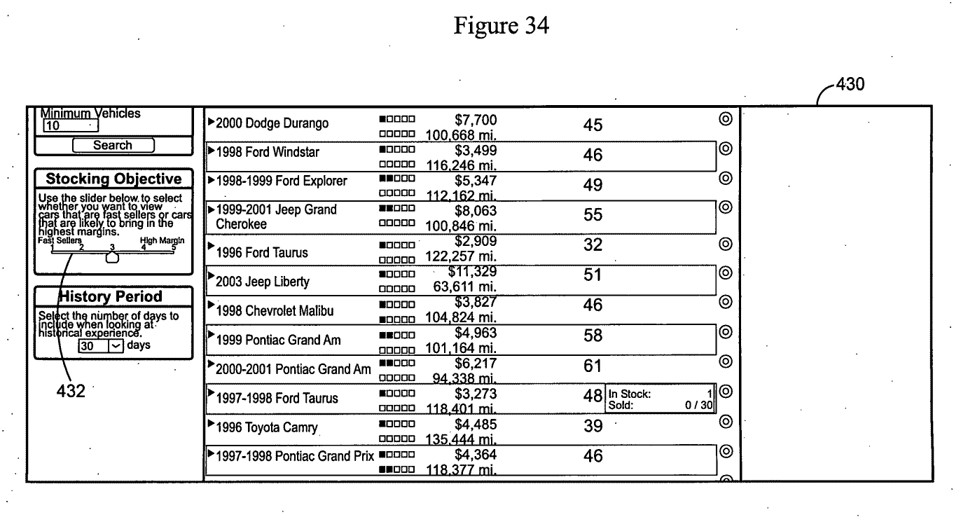

FIGS. 33 and 34 show the Heat Sheet window 430 (FIG. 34 is the same as FIG. 33 but scrolled down to indicate the slider bar). The Heat Sheet window 430 shows the vehicles that best match the dealer's stocking objectives. The dealer can enter various search terms 434 for a particular Vehicle type and class.

The present invention includes “slider bar functionality” 432 as a way of selecting and defining those vehicles to be displayed on each list based on a “slider” 432 which balances multiple metrics including but not limited to market days supply 436 and sales rate data. Additional sorting criterion can also be incorporated. One outcome from sorting used vehicles as currently configured is the ability to pinpoint high demand, high volume, fast turn vehicles as well as high demand, low volume, high margin vehicles. The resulting data are displayed in FIGS. 33 and 34.

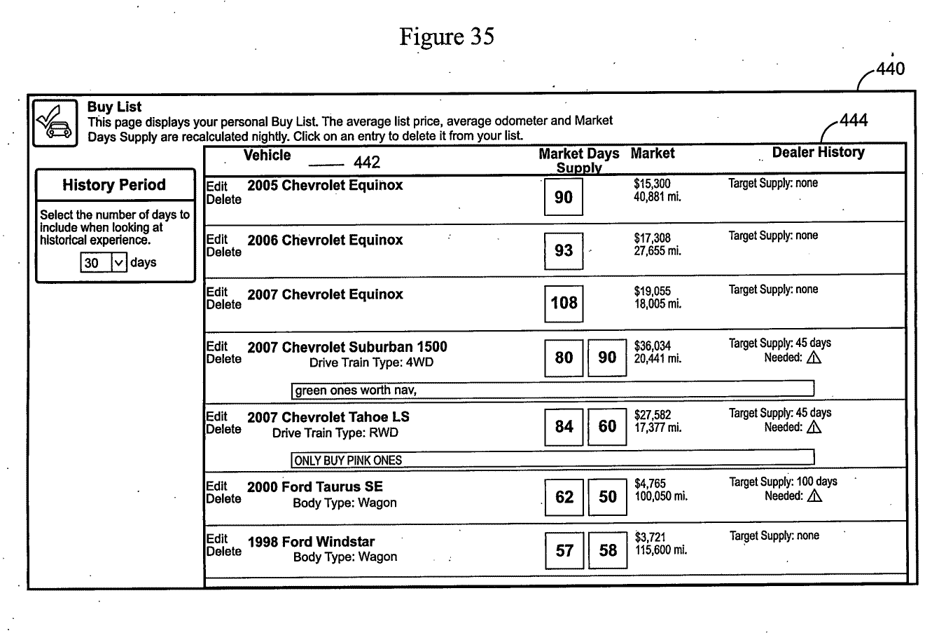

The stocking tool also includes the functionality for a dealer to identify and select which vehicles he might like to stock, thereby creating a unique and distinct buy list 438 for every dealer in his or her market. FIG. 35 shows the Buy List window 440, which includes vehicle detail at the year, make, model level 442 as well as but not limited to vehicle specifications down to a trim level. Dealer history data 444 is incorporated into the Buy List 438, allowing dealers to view their prior results and then set target stocking levels based on their past experience.

While the apparatus and method herein disclosed forms a preferred embodiment of this invention, this invention is not limited to that specific apparatus and method, and changes can be made therein without departing from the scope of this invention, which is defined in the appended claims.

What is claimed is:

1. A method for optimizing the selling price of a focus vehicle to obtain an optimal sale, comprising the steps of:
designating a focus vehicle, said vehicle having a make, model, year and mileage, and having a first selling price;
obtaining the selling pricing and mileage of at least one vehicle-for-sale, said at least one vehicle-for-sale having a similar make, model and year as said focus vehicle;
determining selling information of the focus vehicle based on the selling information of said at least one vehicle-for-sale;
displaying the selling information of said focus vehicle to a user;
allowing for the revision of said selling information of said focus vehicle in order to optimize the selling pricing of the focus vehicle to obtain an optimal sale;
revising the selling information of the focus vehicle;
displaying the revised selling information of said focus vehicle.

2. The method for optimizing the selling price of a focus vehicle to obtain an optimal sale of claim 1, wherein said selling information of the focus vehicle includes the selling price of the focus vehicle.

3. The method for optimizing the selling price of a focus vehicle to obtain an optimal sale of claim 1, wherein said selling information of the focus vehicle includes the profit.

4. The method for optimizing the selling price of a focus vehicle to obtain an optimal sale of claim 1, wherein said selling information of the focus vehicle includes the value ranking.

5. The method for optimizing the selling price of a focus vehicle to obtain an optimal sale of claim 1, wherein said selling information of the focus vehicle includes the number of days to sell the vehicle.

6. The method for optimizing the selling price of a focus vehicle to obtain an optimal sale of claim 1, wherein obtaining the selling pricing and mileage of at least one vehicle-for-sale, comprises the step of allowing for a variance in the mileage of the at least one vehicle-for-sale.

7. The method for optimizing the selling price of a focus vehicle to obtain an optimal sale of claim 1, wherein obtaining the selling pricing and mileage of at least one vehicle-for-sale, comprises the step of allowing for a variance in the model year of the at least one vehicle-for-sale.

8. The method for optimizing the selling price of a focus vehicle to obtain an optimal sale of claim 1, wherein allowing for the revision of said selling information of said focus vehicle in order to optimize the selling pricing of the focus vehicle to obtain an optimal sale, comprises the step of providing for the changing of said selling price of the focus vehicle in order to increase the value ranking or the profit.

9. The method for optimizing the selling price of a focus vehicle to obtain an optimal sale of claim 1, wherein allowing for the revision of said selling information of said focus vehicle in order to optimize the selling pricing of the focus vehicle to obtain an optimal sale, comprises the step of providing for the changing said profit to increase the value ranking or to modify the selling price of the focus vehicle.

10. The method for optimizing the selling price of a focus vehicle to obtain an optimal sale of claim 1, wherein revising the selling information of the focus vehicle comprises calculating new selling information based on the revisions to the previous selling information.

11. The method for optimizing the selling price of a focus vehicle to obtain an optimal sale of claim 1, wherein displaying the selling information of said focus vehicle to the user further comprises the step of displaying the make, model, year, selling price and mileage of said at least one vehicle-for-sale.

12. The method for optimizing the selling price of a focus vehicle to obtain an optimal sale of claim 11, wherein the step of displaying the make, model, year, selling price and mileage of said at least one vehicle-for-sale further comprises allowing for the removal.

13. The method for optimizing the selling price of a focus vehicle to obtain an optimal sale of claim 1, further comprising the step of printing a window sticker for display on said focus vehicle based on the revised selling price of the focus vehicle.

14. A method for optimizing the selling price of a focus vehicle to obtain an optimal sale, comprising the steps of:
designating a focus vehicle, said vehicle having a make, model, year and mileage, and having a first selling price;
obtaining the selling pricing and mileage of at least one vehicle-for-sale, said at least one vehicle-for-sale having a similar make, model and year as said focus vehicle;
determining a first appraisal amount for said focus vehicle, said first appraisal amount containing an appraised value, a profit objective, a price rank, a value rank, and an adjusted percentage of market, said first appraisal amount based in part on the selling information of said at least one vehicle-for-sale;
displaying the first appraisal amount to a user;
allowing for the user to revise at least one of said appraised value, said profit objective, said price rank, said value rank, or said adjusted percentage of market;
determining a second appraisal amount of the focus vehicle;
displaying the second appraisal amount for said focus vehicle to said user.

15. The method for optimizing the selling price of a focus vehicle to obtain an optimal sale of claim 1, wherein said displaying the first appraisal amount to a user includes generating a four square display in which said appraised value is displayed in a first square, said profit objective is displayed in a second square, said price rank and said value rank are displayed in a third square, and said adjusted percentage of market is displayed in a fourth square.
